(19) United States
(12) Patent Application Publication
(10) Pub. No.: US 2012/0262967 A1
(43) Pub. Date: Oct. 18, 2012

(54) SINGLE-STAGE INVERTER WITH HIGH FREQUENCY ISOLATION TRANSFORMER

(75) Inventor: SLOBODAN CUK, Laguna Niguel, CA (US)

(73) Assignee: CUKS, LLC

(21) Appl. No.: 13/086,326

(22) Filed: Apr. 13, 2011

(51) Int. Cl. H02M 7/537

(52) U.S. Cl. 363/131

(57) ABSTRACT

The novel single-stage power processing DC-AC inverter topology with high frequency isolation transformer eliminates the four-transistor unfolding full-bridge stage and provides the output AC voltage at high power conversion efficiency. The new inverter topology has only three switches, two resonant capacitors, a resonant inductor, an output inductor and a small size high-frequency isolation transformer, which does not store the DC energy. The output AC voltage is obtained by the PWM sinusoidal modulation of the duty ratio control of the three switches and can be regulated against the input voltage changes.

### FIELD OF THE INVENTION

The present invention belongs to the category of DC-AC inverters, which convert DC input power, such as from solar cells source and generate an alternating AC power, which is interfaced directly to the utility line to provide the active power to the residential loads. Such High-frequency Isolated Utility Interactive inverters (1,2) are at present composed of two power-processing stages:

1. Conventional isolated DC-DC converter, which is modulated by the duty ratio to generate the 60 Hz rectified AC voltage on the output.

2. The second stage consisting of the four transistors full-bridge converter to result in the 60 Hz sine-wave output voltage which is then interfaced to the utility line.

This two-stage processing is necessitated due to the lack of the converters which can directly convert DC input power to AC, as present DC-DC converters can only generate output DC voltage of one polarity only.

What is needed for direct conversion of DC to AC is a converter topology, which can from input DC source generate output DC voltage of either polarity, hence by using sinusoidal duty ratio modulation produce directly the output AC power in a single power processing stage, thus eliminating the unfolding full-bridge power processing stage.

The present invention is the first such direct DC-AC converter topology which defines a new class of Single-Stage DC-AC converter topologies providing higher efficiency and lower size and cost solutions.

### DEFINITIONS AND CLASSIFICATIONS

The following notation is consistently used throughout this text in order to facilitate easier delineation between various quantities:
1. DC—Shorthand notation historically referring to Direct Current but by now has acquired wider meaning and refers generically to circuits with DC quantities;
2. AC—Shorthand notation historically referring to Alternating Current but by now has acquired wider meaning and refers to all Alternating electrical quantities (current and voltage);
3. i₁, v₂—The instantaneous time domain quantities are marked with lower case letters, such as i₁ and v₂ for current and voltage;
4. I₁, V₂—The DC components of the instantaneous periodic time domain quantities are designated with corresponding capital letters, such as I₁ and V₂;
5. Δv—The AC ripple voltage on energy transferring capacitor C;
6. f_{S}—Switching frequency of converter;
7. T_{S}—Switching period of converter inversely proportional to switching frequency f_{S};
8. S₁, S₂, S₃ are switch designations for DC-AC inverter topology and S and S′ are switch designations for corresponding DC-DC converter topologies.
9. S—Controllable switch with two switch states: ON and OFF;
10. T_{ON}—ON-time interval T_{ON}=DT_{S} during which switch S is turned ON;
11. T_{OFF}—OFF-time interval T_{OFF}=D′T_{S} during which switch S is turned OFF;
12. D—Duty ratio of the main controlling switch S;
13. S′—switch which operates in complementary way to switch S: when S is closed S′ is open and opposite, when S is open S′ is closed;
14. D′—Complementary duty ratio D′=1−D of the switch S′ complementary to main controlling switch S;
15. fᵣ—Resonant switching frequency defined by resonant inductor Lᵣ and energy transferring capacitor C;
16. Tᵣ—Resonant period defined as Tᵣ=1/fᵣ;
17. tᵣ—One half of resonant period Tᵣ;
18. CR—Two-terminal Current Rectifier whose ON and OFF states depend on controlling S switch states and resonant period Tᵣ;

### BRIEF DESCRIPTION OF THE DRAWINGS

FIG. 1a illustrates the prior-art isolated Full-bridge DC-DC converter topology and FIG. 1b shows the full bridge with four transistors which is used as unfolding stage to provide the AC voltage from the output of converter in FIG. 1a.

FIG. 2 illustrates the prior-art two interleaved Quasi-resonant flyback converters that could be used as the a first DC-DC converter stage and followed up by the unfolding stage converter of FIG. 1b to form a two-stage prior-art DC-AC inverter.

FIG. 3a illustrates the present invention which does not need the unfolding stage but still produces the regulated AC sinusoidal output voltage and FIG. 3b are the states of the switches of the converter in FIG. 3a for positive output voltage polarity and FIG. 3c shows the state of the switches of converter in FIG. 3a for negative output voltage polarity.

FIG. 4a illustrates four MOSFET transistors implementation in the converter of FIG. 3a one switch implementations using four MOSFET transistors and FIG. 4b shows the two quadrant characteristic needed for the composite switch comprising S₃ and S₄ MOSFET transistors in FIG. 4a connected back to back and FIG. 4c shows the actual four quadrant characteristic of that switch composite switch.

FIG. 5a shows the present invention of FIG. 3a operated as a DC-DC converter operation with positive polarity of output DC voltage and FIG. 5b shows the present invention of FIG. 3a operated as a DC-DC converter operation with negative polarity of output DC voltage, where the diode direction on secondary side determines the polarity of the output voltage.

FIG. 6a illustrates a non-isolated version of the present invention in FIG. 3a, which also eliminates the unfolding four-transistor stage of conventional DC-AC inverters and FIG. 6b illustrates another implementation of the composite switch comprising S₃ and S₄ RBIGBT transistors for the converter in FIG. 4a.

FIG. 7a illustrates the first non-isolated and non-inverting embodiment of the present invention, FIG. 7b illustrates the second non-isolated and polarity-inverting embodiment of the present invention, and FIG. 7c illustrates the states of two controllable switches for the converters of FIG. 7a and FIG. 7b.

FIG. 8a illustrates implementation of MOSFET switches in the first non-isolated and non-inverting embodiment of the present invention of FIG. 7a, and FIG. 8b illustrates implementation of MOSFET switches in the second non-isolated and polarity-inverting embodiment of the present invention of FIG. 7b.

FIG. 9a illustrates the first isolated and non-inverting embodiment of the present invention and FIG. 9b illustrates the second isolated and polarity-inverting embodiment of the present invention.

FIG. 10a shows that voltage stress on primary side switches of converters in FIG. 9a and FIG. 9b is constant and equal to the input voltage during whole and unlimited duty ratio range from 0 to 1, FIG. 10b shows that voltage stress on a secondary side switch of converters in FIG. 9a and FIG. 9b is constant during whole and unlimited operating duty ratio range from 0 to 1 and is equal to the input voltage divided by the turns ration of the isolation transformer, FIG. 10c shows a branch of converter comprising series connection of the switch and resonant inductor Lᵣ, conducting resonant current iᵣ(t), and FIG. 10d illustrates a huge voltage spike generated across the switch when switch was open to interrupt the current flow of iᵣ(t).

FIG. 11a shows a switching circuit of converter in FIG. 7a when switch S is closed (turned ON) and its complementary switch S′ is open, and FIG. 11b shows a switching circuit of converter in FIG. 7a when switch S is open and its complementary switch S′ is closed.

FIG. 12a shows a voltage waveform across inductor L during switching circuits shown in FIG. 11a and FIG. 11b, FIG. 12b shows an input current waveform of the converter of FIG. 7a, and FIG. 12c shows a DC gain characteristic of the converter in FIG. 7a.

FIG. 13a shows a switching circuit of converter in FIG. 7b when switch S is closed and its complementary switch S′ is open, and FIG. 13b shows a switching circuit of converter in FIG. 7b when switch S is open and its complementary switch S′ is closed.

FIG. 14a shows the capacitor C current of the converter in FIG. 7a, FIG. 14b shows a switching circuit during switching interval when switch S′ of the converter in FIG. 7b is closed, and FIG. 14c is the circuit equivalent to that in FIG. 14b but with the DC voltages canceled to result in final resonant circuit.

FIG. 15a shows a parallel resonant circuit during switching interval when switch S′ of converter in FIG. 7a is closed, FIG. 15b shows a current waveform through capacitor C of converter in FIG. 7a, FIG. 15c shows a current waveform through current rectifier CR of converter in FIG. 7a, and FIG. 15d shows the instantaneous voltage waveform across capacitor C of converter in FIG. 7a.

FIG. 16a shows a switching circuit during switching interval when switch S′ of converter in FIG. 7a is open before the resonant current iᵣ was reduced to zero, and FIG. 16b shows a switching state of switch S and current waveform through the current rectifier CR of converter in FIG. 7a.

FIG. 17a shows the salient waveforms of the experimental prototype for the operation at duty ratio below 50%, FIG. 17b illustrates the salient waveforms of the experimental prototype for the operation at duty ratio around 50%, and FIG. 17c illustrates the salient waveforms of the experimental prototype for the operation at duty ratio above 50% and for operation with constant switching frequency.

FIG. 18a shows the equivalent circuit of converter in FIG. 8a with constant switching frequency of operation and after the resonant current in diode rectifier is reduced to zero and diode is turned-OFF, FIG. 18b shows the current in the bi-directional switch S′ (middle trace) and the diode rectifier current (bottom trace) at duty ratio below 50%.

FIG. 19a shows the instant when switch S′ current is zero at end of switching period salient waveforms of the of the experimental prototype at duty ratio around 50%, and FIG. 19b shows the instant when currents in switch S′ and diode rectifier are both positive

FIG. 20a shows a current waveform through capacitor C of converter in FIG. 7a, with constant T_{OFF} time at high switching frequency, FIG. 20b shows a current waveform change with reduced switching frequency while T_{OFF} time was kept the same as in FIG. 20a, and FIG. 20c shows a current waveform change with additional reduction in switching frequency while T_{OFF} time was kept the same as in FIG. 20a.

FIG. 21a shows the salient waveforms of the experimental prototype for the operation at duty ratio below 50%, FIG. 21b illustrates the salient waveforms of the experimental prototype for the operation at duty ratio around 50%, and FIG. 21c illustrates the salient waveforms of the experimental prototype for the operation at duty ratio above 50% and all with the variable switching frequency operation.

FIG. 22a illustrates a current waveform through the current rectifier CR of converter in FIG. 7a when duty ratio is D=0.33, FIG. 22b illustrates a current waveform through the current rectifier CR of converter in FIG. 7a when duty ratio is D=0.5, and FIG. 22a illustrates a current waveform through the current rectifier CR of converter in FIG. 7a when duty ration is D=0.67, while the resonant current interval is adjusted accordingly to always equal to the OFF-time interval D′T_{S}.

FIG. 23a illustrates the first non-isolated and non-inverting embodiment of the present invention of FIG. 8a in which MOSFET switches are replaced with a model of an ideal switch with parasitic capacitor and body diode connected in parallel, FIG. 23b illustrates state of the switches S and S′ with two “dead time” intervals needed for a “stressless” switching, FIG. 23c illustrates a current waveform through capacitor C in FIG. 23a, and FIG. 23d illustrates voltage waveforms on switches S and S′ in FIG. 23a with two natural transition intervals t_{N1} and t_{N2} uniquely present in the new stressless switching.

FIG. 24a illustrates the salient waveforms of the experimental prototype during stressless switching of switches S and S′ in the converter of FIG. 8a at full load FIG. 24b illustrates waveforms of FIG. 24a during enlarged D to D′ sressless switching transition, and FIG. 24c illustrates waveforms of FIG. 24a during enlarged D′ to D stressless switching transition.

FIG. 25a illustrates the salient waveforms of the experimental prototype during stressless switching of switch S in converter of FIG. 23a at 50% load current condition, FIG. 25b illustrates waveforms of FIG. 25a during enlarged D to D′ stressless switching transition, and FIG. 25c illustrates waveforms of FIG. 25a during enlarged D′ to D stressless switching transition.

FIG. 26a illustrates another non-isolated and non-inverting embodiment of the present invention in which resonant inductor Lᵣ is in series with energy transfer capacitor C and FIG. 26b illustrates another non-isolated and polarity-inverting embodiment of the present invention in which resonant inductor Lᵣ is in series with energy transfer capacitor C.

FIG. 27a illustrates another non-isolated and non-inverting embodiment of the present invention in which resonant inductor Lᵣ is in series with complementary switch S′ and FIG. 27b illustrates another non-isolated and polarity-inverting embodiment of the present invention in which resonant inductor Lᵣ is in series with complementary switch S′.

FIG. 28a illustrates another isolated and polarity non-inverting embodiment with the resonant inductor Lᵣ placed in series with the primary side capacitor C₁ and FIG. 28b illustrates another isolated and polarity inverting embodiment with the resonant inductor Lᵣ placed in series with the primary side capacitor C₁.

FIG. 29a illustrates the non-isolated and non-inverting embodiment of the present invention of FIG. 7a in which energy transfer capacitor C is split in two in-series capacitors C₁ and C₂, FIG. 29b illustrates converter of FIG. 29a with inserted magnetizing inductance Lₘ, and FIG. 29c illustrates a voltage waveform and volt-seconds balance across magnetizing inductance Lₘ in FIG. 29b.

FIG. 30a illustrates instantaneous voltage waveform across capacitor C₁ in FIG. 29b, FIG. 30b illustrates instantaneous voltage waveform across capacitor C₂ in FIG. 29b, FIG. 30c illustrates the sum of the two instantaneous voltage waveforms from FIG. 30a and FIG. 30b, and FIG. 30d illustrates the switching circuit of converter in FIG. 29b during resonant time interval when complementary switch S′ is closed.

FIG. 31a illustrates the non-isolated and polarity-inverting embodiment of the present invention of FIG. 7b in which energy transfer capacitor C is split in two in-series capacitors C₁ and C₂, FIG. 31b illustrates converter of FIG. 31a with inserted magnetizing inductance Lₘ, and FIG. 31c illustrates a voltage waveform and volt-seconds balance across magnetizing inductance Lₘ in FIG. 31b.

FIG. 32a illustrates sum of instantaneous voltages on capacitor C₁ and C₂ in FIG. 31b, FIG. 32b illustrates input DC voltage V_{g} FIG. 31b, FIG. 32c illustrates a difference of the voltage waveforms from FIG. 32a and FIG. 32b, and FIG. 32d illustrates switching circuit of converter in FIG. 31b during resonant time interval when complementary switch S′ is closed.

FIG. 33a illustrates a voltage waveform of the transformer for two different converters: a) dotted line is for the forward converter b) heavy lines are for present invention, and FIG. 33b illustrates the transformer volt-seconds (VS) as a function of operating duty ratio D for two converters: a) dotted lines are for forward b) heavy lines are for present invention.

FIG. 34a illustrates the secondary side rectification of the forward and AHB converters, FIG. 34b illustrates voltage stresses of the secondary side switches in forward converter, FIG. 34c illustrates the voltage stress of the diode switch of the present invention, and FIG. 34d is the DC voltage gain of forward converter and present invention.

FIG. 35a shows the graph of Volt-seconds of the transformer of present invention as a function of operating point, and FIG. 35b illustrates the voltage stress of the diode of the present invention as a function of the operating point.

FIG. 36a is circuit schematics of the Integrated Magnetics extension of the present invention, FIG. 36b is the Integrated Magnetics implementation for the converter in FIG. 36a, FIG. 36c shows the low ripple output voltage under the zero ripple current condition, FIG. 36d illustrates the output ripple current before magnetic coupling (dotted line) and after magnetic coupling (heavy lines) into an Integrated Magnetics structure of FIG. 36b, and FIG. 36e shows the component of current in switch S′ which help eliminate switching losses during second (D′ to D) transition.

FIG. 37a shows the efficiency measurement results made on a 600 W prototype, and FIG. 37b shows the power losses measured on 600 W prototype.

FIG. 38a illustrates the stressless switching of the primary side switches of the 600 W prototype at full load current, FIG. 38b shows the enlarged first transition (D to D′) and zero voltage switching of switch S′, and FIG. 38c shows the enlarged second transition (D′ to D) and zero voltage switching of switch S.

### OBJECTIVES

### Stand Alone System Concept

We first introduce a standalone (SA) system concept which can operated from the intermediate storage system, such as battery to provide the AC line voltage independent of the utility to supply the power to the AC loads. The AC loads can therefore be purely resistive providing active power. However, the standalone inverters are also capable to provide a reactive power as well, so they can operate the appliances such as motors, which require the reactive power as well.
The present invention, the DC-AC inverter, is with the proper switch implementation capable of operating as a standalone inverter as describe in later sections.
We now describe next the Utility Interactive (UI) system concept (1,2).

### Utility Interactive System Concept

This concept is used to provide the Dc power from the solar arrays to provide active power directly to the utility AC line.

The solar array power fluctuates considerably during each day depending on the insulation level, whether conditions (clouds), etc. The residential load current also experiences extremely wide variations in the course of the day depending on actual usage of various appliances, in the residence. Hence the need to balance the source and load power is created, for which the two systems are available: stand alone (SA) system requiring intermediate battery storage and operating independently of utility line and a Utility Interactive (UI) system which is interfaced directly to utility line.

In this Utility Interactive (UI) system (1, 2), the inverter operates in parallel with the utility line to supply a common residential load with the active power. In this concept, the already available utility distribution AC system is used to balance the power flow between the DC source and AC residential load with the AC line already providing the reactive power demanded by the AC load so that UI inverter is left to produce the active power only by feeding the utility line with the sinusoidal current in phase and proportional to the line voltage.

Efficiency, size and cost of UI inverter, depend mainly on efficiency, size and cost of the DC-AC inverter used for the power processing part. In (1, 2) the conventional two-stage power processing consists of a Push-pull primary, full-bridge secondary isolated DC-DC converter followed by the mandatory second-stage consisting of four transistors unfolding full-bridge stage. This method uses total of 11 switches, 6 of them transistors and 5 of them diode rectifiers.

The control strategy of how to interface the output of the DC-AC inverter to the utility line, which is a stiff voltage source, is also described in details in (1, 2). Furthermore (1, 2) describe one method of Peak Power Tracking and corresponding circuitry.

The objective of the present invention is to introduce a new single-stage DC-AC inverter topology, which eliminates the second unfolding stage and provides the AC output power directly in a Single-stage power processing consisting of minimum number of switches (four transistors), so as to increase the efficiency and reduce the size and cost of the DC-AC inverter. Clearly, the same utility interface control method as used in (1, 2) can be directly implemented to the present invention, the new DC-OAC inverter. Likewise the Peak Power Tracking circuitry disclosed in (1, 2) can also be directly implemented to the present invention. Those skilled in the art may find use of the other analog and digital methods for utility interface and for peak power tracking, which could also be implemented in the basic Single-Stage DC-AC inverter disclosed with this invention.

### Solar Cells Shading Effect

Another practical aspect in extracting maximum available power from the solar cells is in proper configuration of solar cells with their serious connection to generate the single array. When too many solar cells are connected in series to form a high voltage of 200V DC, the shading effect reduces their effectiveness, as the single cell, which is not insolated, prevents all solar cells connected in series to produce any power. Consequently, the preferred approach is to have the solar array single panel produce an average voltage of 30V or so. The DC-AC inverter has therefore the role to increase that voltage through its isolation transformer step-up turns ratio to the high output voltage commensurate with 220V AC line for example. The isolation transformer has therefore important role to provide this step-up function operating at high switching frequency and efficiently and with the smallest size. This is another objective of the present invention as it introduces an AC transformer with small size and no DC energy storage.

### PRIOR-ART

### DC-AC Inverters Used for Utility Interface

The prior art DC-AC inverters are based on the cascade of the two power processing stages:

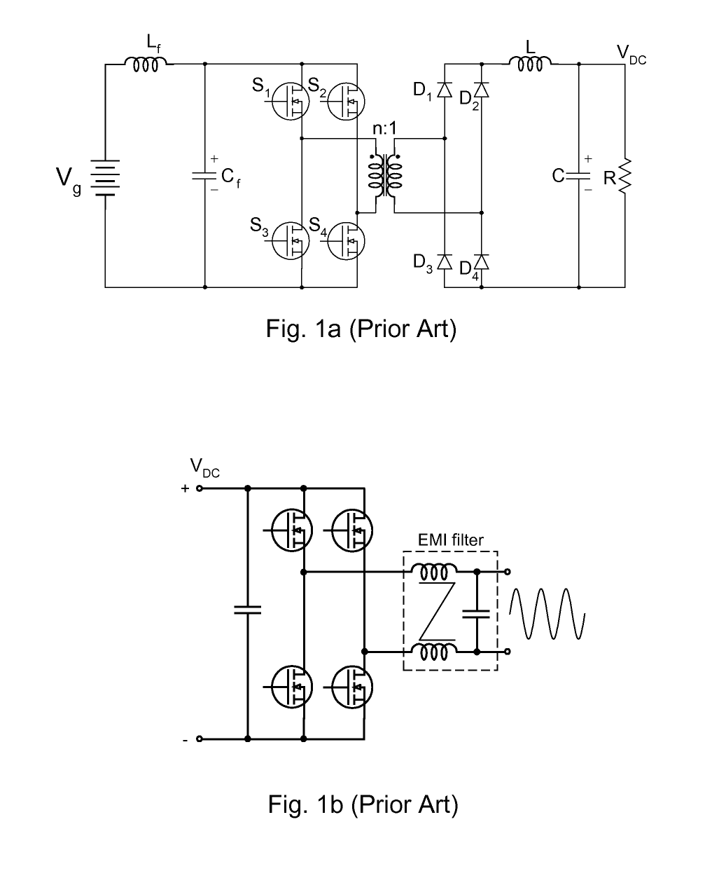

1. First stage is a DC-DC converter, such as Full-bridge Isolated DC-DC converter shown in FIG. 1a which operates at the high switching frequency such as 100 kHz and whose switches are modulated by the duty ratio D of the main controlling switch so that the output voltage can be controlled by the duty ratio D. The duty ratio D is modulated in such a wave to obtain the rectified sine-wave voltage of 50 Hz at the output.

2. The second stage is another full-bridge unfolding stage consisting of four active switches, the transistors, such as shown in FIG. 1b. However, this stage operates at the line frequency such as 60 Hz. Its function is to unfold the rectified 60 Hz sine-wave into a full 60 Hz sine-wave. This topology therefore has a total of 12 switches, 8 of them transistor and four diode switches.

The additional control circuits are then used to interface the output sinusoidal voltage to the utility line. Likewise, when the input voltage consists of the solar array, additional Maximum Power Tracker circuitry is used to extract the maximum power from the solar cells. Both of these control functions can be implemented in variety of ways and are known to those skilled in the art.

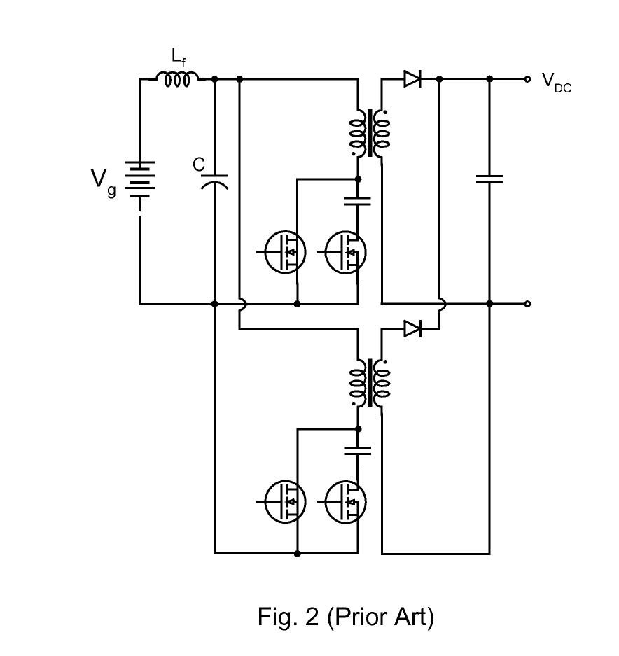

Another prior-art DC-AC inverter topology is shown in FIG. 2 to consists of two interleaved flyback converters, which are then also followed by the unfolding four-transistor power processing stage of FIG. 1b. This configuration has a total of 10 switches, eight transistors and 2 diodes. There are many other variants, which are obtained by using different bridge topologies for Isolated DC-DC converter such as push-pull DC-DC converter and half-bridge DC-DC converter

### SUMMARY OF THE INVENTION

### Single-Stage DC-AC Inverter

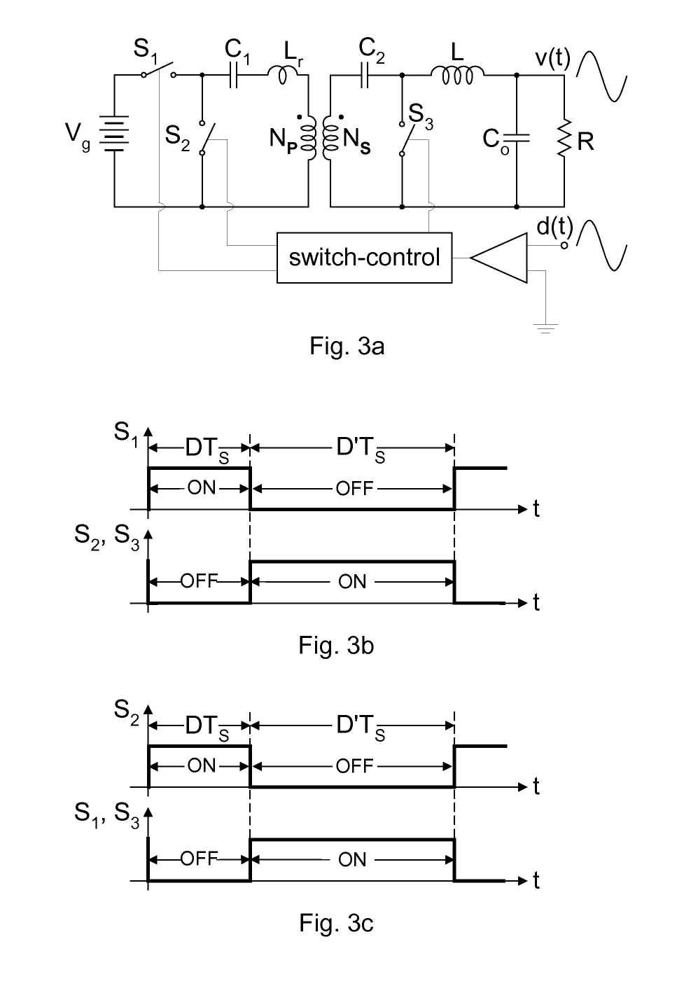

The present invention in FIG. 3a does not need any unfolding full bridge stage on the output and is therefore a truly Single-Stage Inverter topology. Its single-stage topology consists of two switches, S₁ and S₂ on the primary side of the isolation transformer and a single switch S₃ on the secondary side. There are two distinct switching intervals, ON-time interval and OFF-time interval. The state of the three switches during these two intervals are shown in:

1. FIG. 3b for the case when the output voltage polarity is positive.
2. FIG. 3c for the case when the output voltage polarity is negative.

The inverter topology also has three magnetic components: the isolation transformer with Nₚ: N_{S} turns ratio, the output inductor L and the resonant inductor Lᵣ. One position of the resonant inductor is as shown in FIG. 3a on the primary side of the transformer and in series with the primary. As this is also the position of the leakage inductance of the isolation transformer in many applications there would be no need to use a separate external resonant inductor, as the leakage inductance may be used to take that role. This immediately suggests, that the energy stored in this leakage inductance is not dissipated as in conventional square wave converters, but is in fact discharged in a non-dissipative and resonant way, thus eliminating related losses. This, in addition, helps eliminate the high voltage spikes present on switches in conventional PWM converters.

There are also a number of other places that the external resonant inductor may be placed. Some of them will be shown in other implementations in other extensions. Other positions not shown are also, generally well known to those skilled in the art and not included here.

Finally, the converter has two capacitors, capacitor C₁ connected to the resonant inductor and capacitor C₂ connected to the transformer secondary. These capacitors perform the dual role: during the ON-time interval they are operating like a PWM capacitors charging in linear fashion while during the OFF-time interval they operate as the resonant capacitors discharging in resonant way. One of the operational modes is to have this resonant capacitor discharge and the resonant interval strictly contained to the fixed OFF-time interval and to control the output voltage by varying the ON-time interval, hence effectively using a duty ratio control with a variable switching frequency. Note that despite the presence of the resonant discharge and large resonant capacitor discharge current, the control of the output voltage is still obtained by the standard duty ratio control and not via resonant control methods.

### Generation of the Sinusoidal Output Voltage at Line Frequency

As the unfolding stage is eliminated from the power processing stage of the present Single-stage inverter, the generation of the full-wave sinusoidal voltage on the output must be obtained by different means. This is accomplished by a special drive and control of the three switches as also illustrated in FIG. 3a. As shown in FIG. 3a the duty ratio D is modulated in the sinusoidal way at the line frequency wₗ so that as a function of time it can be described as d(t)=Dₘ sin(wₗt). By use of the comparator in FIG. 3a the continuous duty ratio modulation is converter into a pulse width modulation (PWM) on the output. Switch-control block shown also in FIG. 3a is then controlling the three switches so that the sinusoidal output voltage v(t)=Vₘ sin(wₗt) at the line frequency is obtained on the output. Switch-control block operates the three switches based on the output voltage polarity as follows:

1. For positive output voltage polarity, switch S₁ is turned ON during the ON-time interval and switches S₂ and S₃ are turned-OFF, while during the OFF-time interval the switch S₁ is turned OFF and switches S₂ and S₃ are turned ON as seen in FIG. 3b.

2. For negative output voltage polarity, switch S₂ is turned ON during the ON-time interval and switch S₁ and S₃ are turned OFF, while during the OFF-time interval switches S₁ and S₃ are turned ON and switch S₂ is turned OFF as seen in FIG. 3b.

Switch-control block in FIG. 3a can be implemented in many different ways known to those skilled in the arts, such as using either analog circuits or digital circuits or the combination of both.

### Switch Implementation

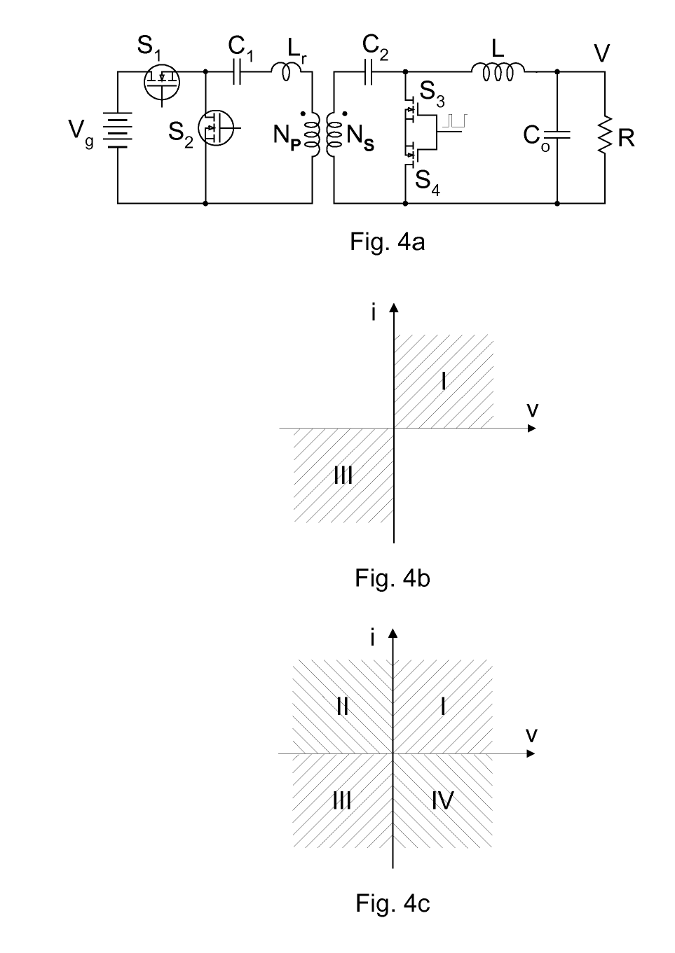

The implementation of the three ideal switches with MOSFET transistors is shown in FIG. 4a. The two primary side transistors are operated out of phase so a standard low side, high side driver can be used to drive them.

Note, however the special implementation of the composite switch comprising of switches S₃ and S₄ shown in FIG. 4a. This composite switch due to the presence of the AC output voltage at 60 Hz line frequency, must operate as a AC switch so it must meet the two-quadrant switch operation illustrated in FIG. 4b. Present technology of the Power MOSFET with its vertical power flow structure and presence of the body diode prevents single switch implementation so that a composite switch consisting of two n-channel MOSFET devices connected back to back with common source regions and common gates must be used as illustrated in FIG. 4b. Such composite switch implementation, due to presence of the body diodes in the MOSFET switches, actually operates as a four-quadrant switch illustrated in FIG. 4c As the result of such switch implementation, the converter of FIG. 4a can operate as a standalone DC-AC inverter.

### Bi-Directional Current and Power Flow

The MOSFET transistors are current bi-directional devices, which are capable conducting the current in either direction. The DC-AC inverter of FIG. 4a has all four switches implemented with the MOSFET transistors. Therefore this topology is not only capable of transferring the power from DC to AC with Unity Power Factor, but also can process the power in the opposite directions, form AC to DC also with the Unity Power Factor.

Therefore, this converter may find another use to interface the DC transmission line to an AC-transmission line and provide the power flow in either direction depending on the appropriate control strategy, which can dictate power flow in either direction. This will result in natural load balancing between two transmission systems. For example, the DC transmission line would predominantly have its power provided by the solar cell during the day, while the AC power transmission line power is provided by the coal and nuclear power plants which produce power even during the night when the consumption is much lower.

Thus, during the day, DC transmission line could provide the access power to the AC transmission line using this bi-directional DC-AC inverter, while during the night AC transmission line would provide the excess power to the DC transmission line using the same inverter operating as an AC-DC rectifier.

### Explanation of the Elimination of the Unfolding Stage

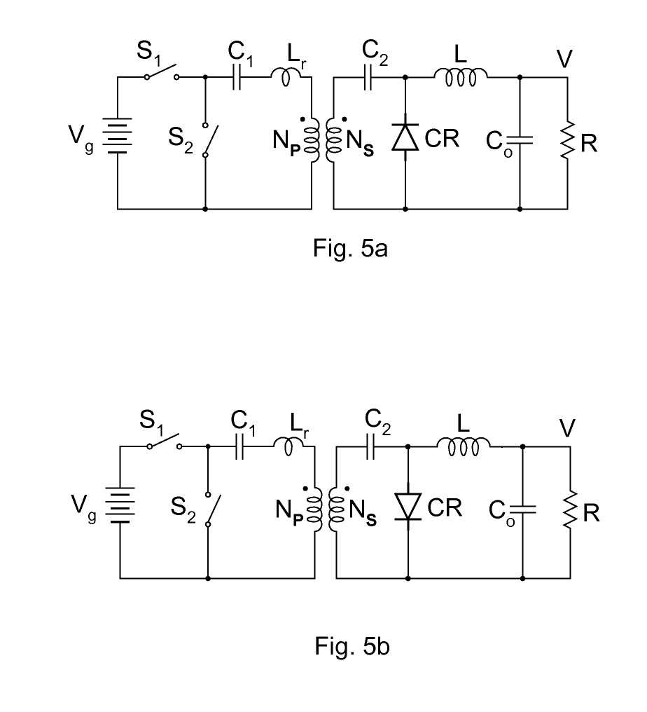

To clearly explain how the unfolding stage is eliminated from the power processing part and its function achieved strictly by control means in the new Single-Stage inverter topology we use the two converter topologies in which a single diode rectifier implements the output switch. Note first, how the direction of the diode directly changes the polarity of the output voltage from positive output voltage polarity in FIG. 5a, to negative output voltage polarity as seen in FIG. 5b.

Note also how with the polarity change of the output voltage there is also direct change of the operation of the two primary side switches:

1. For positive output voltage polarity the switch S₁ is turned ON during the ON-time interval DT_{S} as shown in FIG. 5a.
2. For negative output voltage polarity the switch S₂ is turned ON during the ON-time interval.

Such operation of the switches on primary side will result in the same DC voltage gain as a function of duty ratio D given by V=DV_{g} as will be shown in detailed analysis in remaining sections.

### Elimination of Leakage Losses

The present DC-AC inverters based on the flyback and bridge-type DC-DC converter topologies have performance and efficiency drawbacks due to the losses incurred in the energy stored in the transformer leakage inductance, which must be removed by use of dissipative snubers. The present invention in FIG. 3a eliminates the losses due to the leakage inductance of the isolation transformer. Note the presence of the resonant inductor with the primary of the isolation transformer. Due to the capacitive charge and resonant discharge of the primary resonant capacitor, the energy stored in the leakage inductance during the ON-time interval is released in a non-dissipative wave during the OFF-time resonant interval. This also eliminates any spikes on switches usually present in conventional DC-DC converters. This clearly leads to both higher efficiency and permits operation at higher switching frequencies to reduce the size of the magnetic components.

### Elimination of Switching Losses of Switches on Transformer Primary Side

The two switches on the transformer primary side are operated so that there are two transition intervals during which both transistors are turned OFF. The primary side resonant capacitor then with its alternating current due to its charge and discharge facilitates the natural exchange of the energy stored on the parasitic drain-to-source capacitances of the two switches, so that at each of the two transitions, the respective transistor drain to source voltage is reduced to zero before it is turned ON resulting in no switching losses and elimination of the spike voltages on the respective transistors. This is explained in more details in the later sections and confirmed experimentally. This also leads to higher efficiency and permits the operation at higher switching frequencies.

### Non-isolated Single-Stage DC-AC Inverter Embodiment

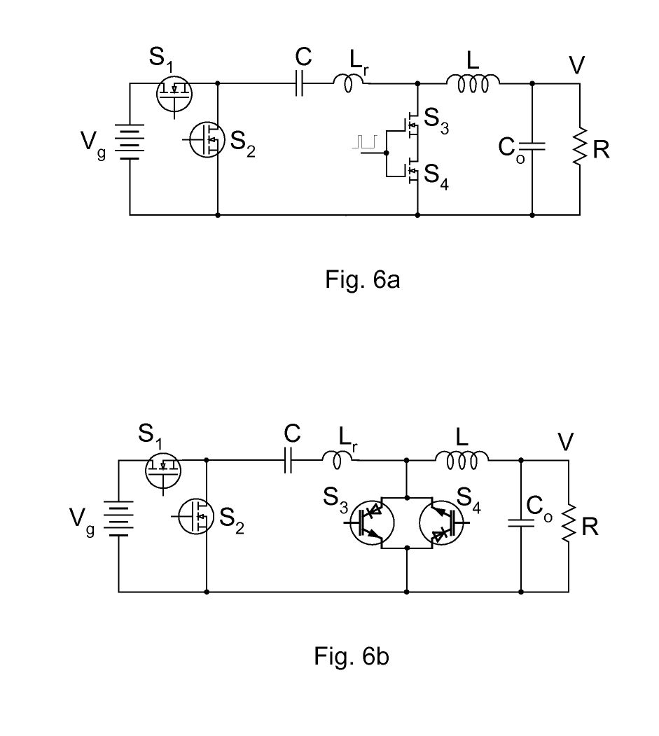

In some applications no isolation is required, nor the voltage scaling by the transformer turns ratio. In that case Single-Stage inverter can be further simplified by shorting the transformer and combining two capacitors in series to result in a single capacitor and a Single-Stage non-isolated DC-AC inverter shown in FIG. 6a, which also eliminates the need for the unfolding four transistors full bridge stage.

FIG. 6b shows another implementation of the composite switch comprising S₂ and S₃ switches but this time using the two switches connected in parallel and each switch implemented by a Reverse Blocking IGBT (RBIGBT) transistors. Note that that this composite switch operates so that S₃ switch operates in first quadrant for positive polarity output voltage and is OFF for negative output voltage polarity. The switch S₄ on the other hand operates in third quadrant for negative output voltage polarity and is OFF for positive output voltage polarity.

### Basic Operation and Analysis of DC-DC Converters

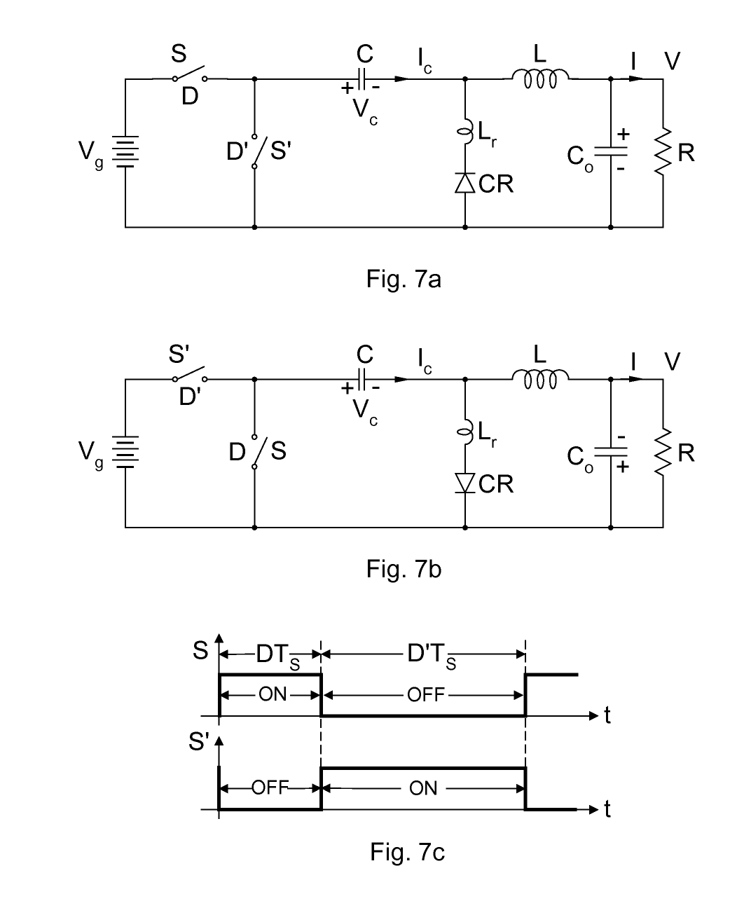

For this DC-DC converter analysis the notation is slightly modified. The two input switches are designated as S and S′ to signify their out of phase operation. The third switch is most often implemented as a current rectifier and designated Cᵣ in FIG. 7a while the switch states are shown in FIG. 7b.

We now undertake detailed analysis separately for the case when the output voltage is not an AC voltage, as in previous sections, but either positive or negative DC voltage. For the purpose of deriving and understanding the operation of the original DC-AC inverter in FIG. 3a.

### Non-isolated DC-DC Converter Topologies

The non-isolated DC-DC converter versions of the present invention have two basic variants: a non-inverting version shown in FIG. 7a and polarity inverting version shown in FIG. 7b. Both circuit feature a rather unorthodox configuration consisting of three switches contrary to the Square-wave switching theory (1) that switches ought to come in complementary pairs only. For example, all presently known switching DC-DC converters have switches, which come in pairs thus having 2, 4, or 6 switches that is an even number of switches.

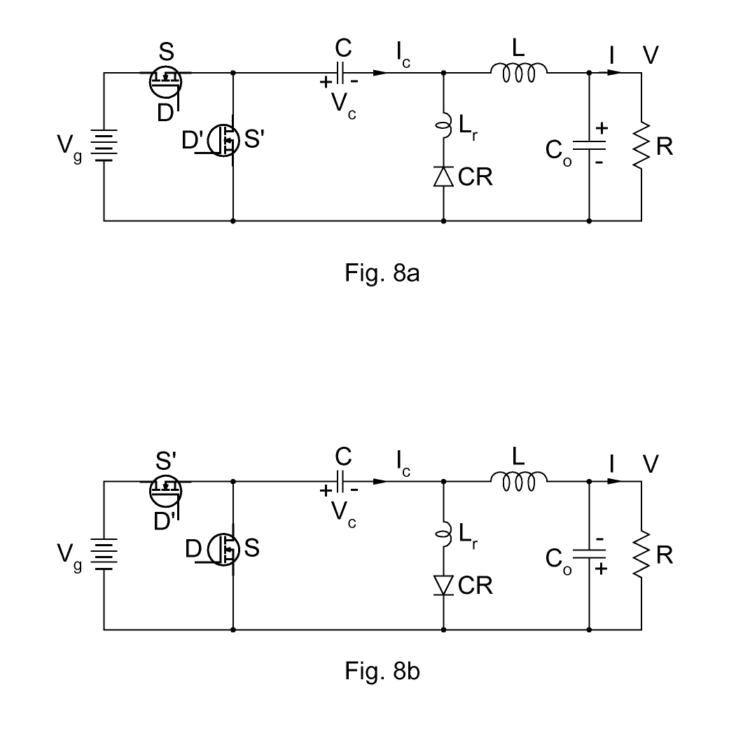

Two of the switches, marked S and S′ in FIG. 7a, are controlling switches and operate out of phase as per switch state diagram illustrated in FIG. 7c. Furthermore, as the later analysis reveals, the active switch S′ must be in its minimum realization be a current bi-directional switch, such as MOSFET. They can be implemented as a three terminal active transistor switches such as MOSFET transistors illustrated in FIG. 8a and FIG. 8b. The third switch can be implemented in the simplest form as a passive two terminal current rectifier (CR) device (diode), which turns-ON and turns-OFF in response to particular circuit conditions dictated by both the controlling switches S and S′ and the choice of the value of the resonant inductor Lᵣ and capacitor C as described in later section on detailed operation of the converters.

### Isolated DC-DC Converter Topologies

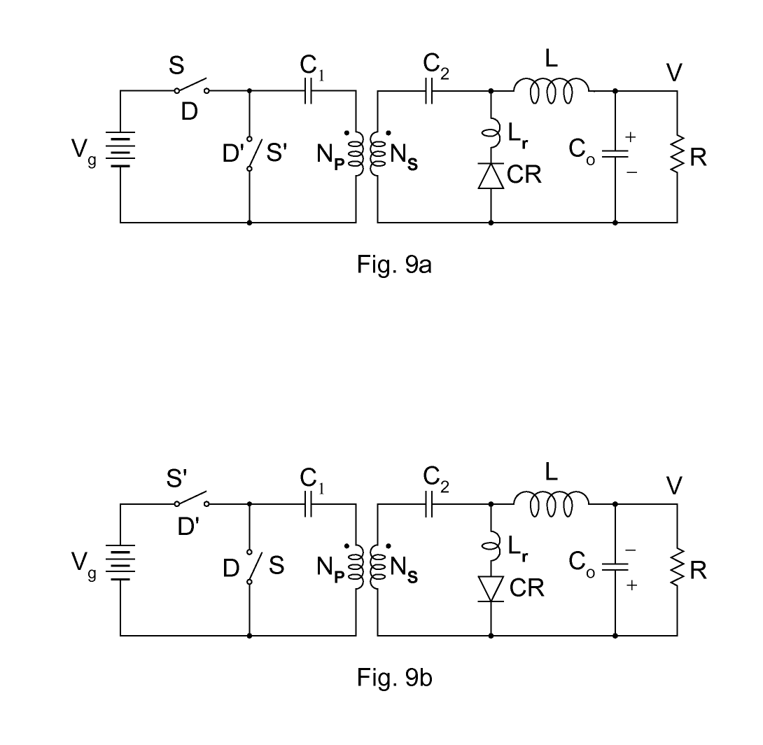

By splitting the floating energy transfer capacitor C into two capacitors C₁ and C₂ and inserting an isolation transformer with N_{P}: N_{S} primary to secondary turns ratio in each of the two converters of FIG. 8a and FIG. 8b, the respective galvanically isolated configurations are obtained as illustrated in FIG. 9a and FIG. 9b respectively. The voltage stresses on the switches are:

V_{S}/V_{g}=V_{S′}/V_{g}=1 (1)

V_{CR}/V_{g}=1/n (2)

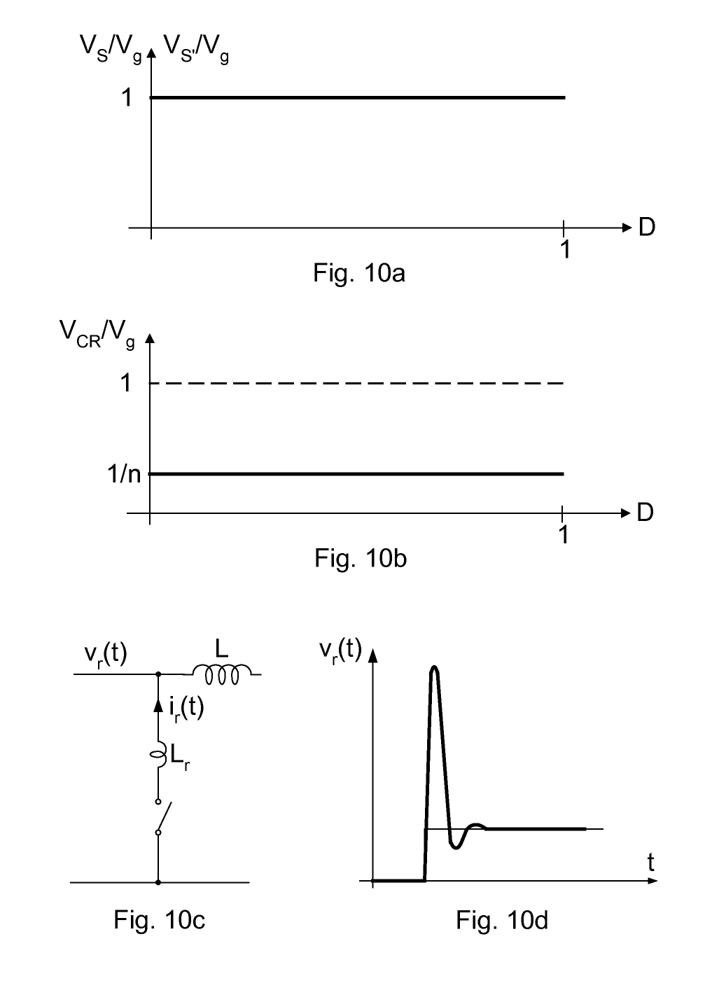

and are illustrated by graphs in FIG. 10a and FIG. 10b. Note that all three switches can be operated throughout the operating duty ratio D from 0 to 1 without a fear of any of the switches “blowing up”: the input switches have the most desirable minimum voltage stress equal to the input DC voltage. The single output rectifier switch also has a low voltage stress equal to input DC voltage divided by the step-down turns ratio n or multiplied by the step-up turns ratio 1/n.

As a direct benefit, a wide input voltage range is possible without any penalty on the circuit operation. This is in stark contrast to present converters, either square-wave type or resonant types, which operate within a very narrow input voltage range. In present invention, a safe operation of the switches is always guaranteed not only during the steady state conditions, but also even during any transient conditions, such as start-up and shut down, short circuit conditions, or even any abnormal operating conditions. This clearly increases significantly not only efficiency but also converter reliability too. Therefore, lower cost, lower conduction losses, and high efficiency can be achieved simultaneously.

Note another embodiment of present invention in which the resonant indictor Lᵣ is connected in the branch with output diode CR. Conventional square-wave converters explicitly forbid such a placement of the inductor for apparently obvious reason: the inductor current cannot be interrupted as it will develop a huge voltage spike across inductor and result in large voltage exceeding rating of the switch and hence in its destruction as illustrated in FIG. 10c and FIG. 10d. The following detailed analysis will, however, show that the converter of the present invention operates in such a way that this placement of the inductor in switch branch is not only permissible, but actually crucial for the operation of the converter and its many advantages.

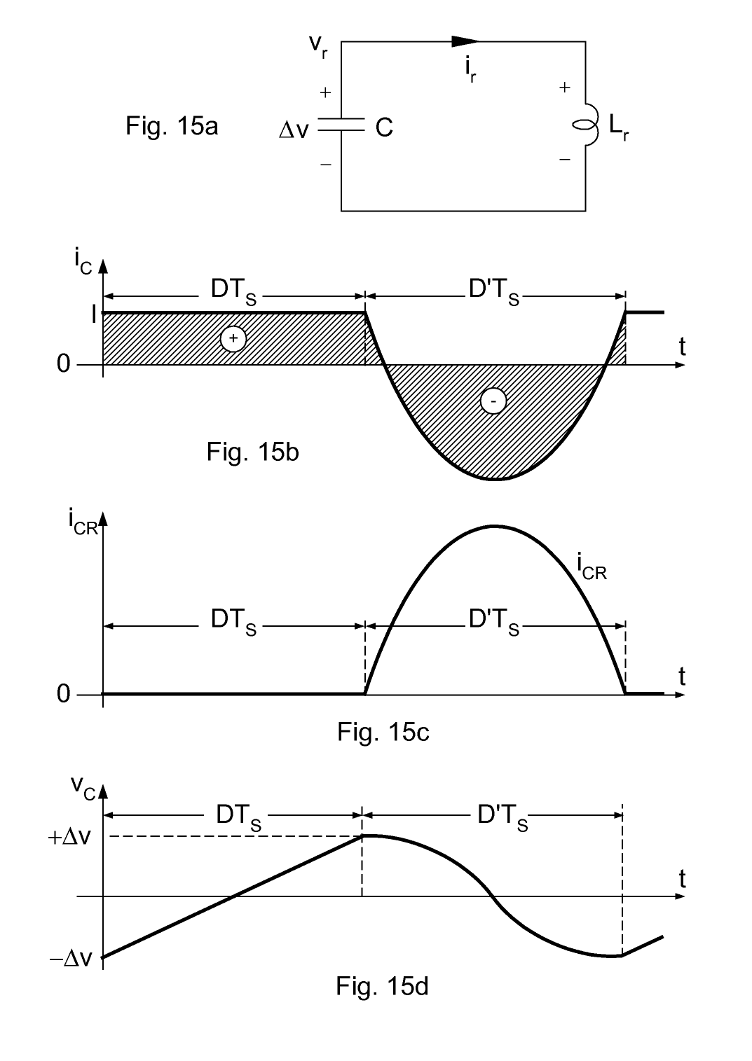

The three-switch configuration of present invention has additional advantages. Note that the diode switch CR is ideally turned-ON at zero current at the beginning of the OFF-time interval, D′T_{S} interval, and turned-OFF at zero current level at the end of the resonant interval D_{R}T_{S} (FIG. 15c). As long as the OFF-time interval is long enough to allow the full discharge of energy transfer capacitor, the diode CR current reduces to zero and this diode is thus turned OFF under ideal zero current condition. This, in fact, eliminates the substantial turn-OFF losses of conventional converters caused by long reverse recovery time and high reverse currents of diodes. Since inductor Lᵣ releases all its stored energy before the switch CR turns-OFF, there are no turn-OFF losses of that switch. The single diode switch on the output therefore operates under the ideal conditions: zero voltage and zero current turn-ON and zero voltage, zero current turn-OFF. This is in stark contrast to the operation of all present converters, such as forward converter, for example, in which the two output switches do not operated under such preferable switching conditions and actually have a basic problem during both switching transitions: the output inductor current needs to commutate from one output rectifier switch to the other. Since it cannot be done instantaneously, the cross conduction occurs resulting in large current spikes during switching transitions requiring proper derating of the switches. This also results in unwanted high frequency noise.

### Summary of the Advantages of DC-DC Converter Operation

The advantages of DC-DC converter operation of the present invention can be therefore summarized as follows:
1. Step-down or step-up isolated converter, which provides high efficiency operation;
2. Polarity inverting configuration for non-isolated converter;
3. Voltage stresses of current rectifier on secondary side limited to input DC voltage divided by transformer step down turns ratio or multiplied by transformer step-up ratio.
4. Voltage stress of the input switches limited to input DC voltage;
5. Wide input voltage range;
6. Isolation transformer makes possible additional voltage step-up or step-down based on transformer turns ratio n;
7. Small and efficient isolation transformer with no stored DC energy;
8. Integration of output inductor and isolation transformer leads to further performance improvements, such as very low output ripple voltage;
9. Constant OFF-time operation optimizes performance over wide input voltage range.

### BACKGROUND OF THE INVENTION

### Detailed Analysis of the Non-isolated Step-down DC-DC Converter

We now undertake the detailed analysis of the non-inverting converter of FIG. 7a with the objective to find DC conversion ratio and the salient waveforms of the converter, such as current in inductors and voltages on capacitors.

### Hybrid Switched-Mode Power Conversion

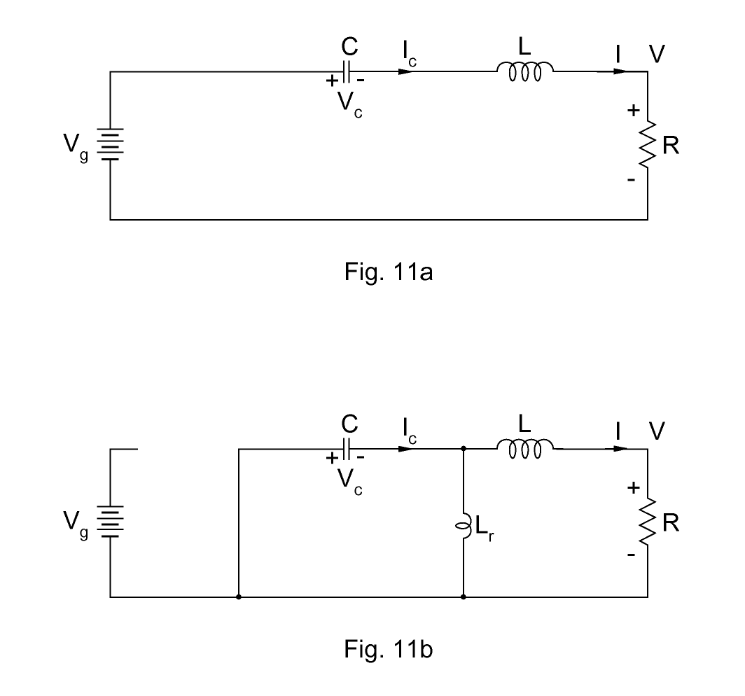

We assume a constant switching frequency of operation and duty ratio control D of the main switch S. First, we identify two linear switched networks: one for the ON-time interval DT_{S} shown in FIG. 11a and the other for the OFF-time interval D′T_{S} shown in FIG. 11b. Note that the large output filtering inductor L is subjected to the same square-wave voltage excitations as in standard square wave converters for both parts of the switching interval. However, the small resonant inductor Lᵣ forms a parallel resonant circuit with the energy transferring (and floating) capacitor C. Clearly this will lead to sinusoidal resonant current waveform of resonant inductor and co-sinusoidal resonant ripple voltage waveform of the capacitor C taking place during the OFF time interval D′ T_{S}. It is apparent that this conversion method is different from conventional square-wave conversion method in which switch voltages and currents are all square-wave-like. It is also different from classical resonant converters in which both switch voltages and switch currents are all sinusoidal like for both switching intervals. Therefore, this conversion method is appropriately termed a hybrid switched-mode power conversion due to its unique combination of the two different conversion methods and their respective waveforms. The two switching intervals are also appropriately named square-wave interval for ON-time interval and resonant for OFF-time interval.

### DC Analysis of Non-inverting DC-DC Converter

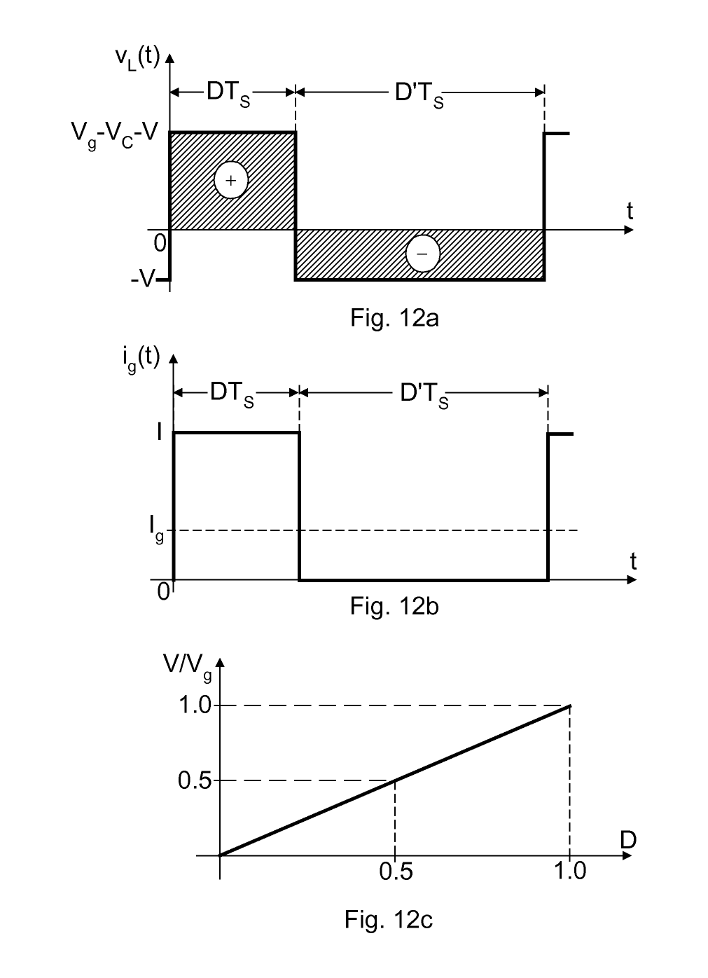

To find the steady-state properties such as DC voltages on capacitors and DC currents through inductors as a function off the operating duty ratio D we can employ the volt-second balance on main inductor L as shown in FIG. 12a. Note that the square-wave voltage across big output inductor L is completely unaffected by the presence of the small resonant inductor Lᵣ. Thus we get:

D(V_{g}−V_{C}−V)=(1−D)V (3)

From input current waveform shown in FIG. 12b, the average input current I_{g} is also completely unaffected by the presence of the resonant inductor Lᵣ, as the current drawn from the source is equal to load current I during ON-time interval. Thus,

I_{g}=DI (4)

Finally, the resonant exchange of the energy between capacitor C and resonant inductor Lᵣ during OFF-time interval as per FIG. 11b is lossless. Thus, we can invoke a 100% efficiency argument to obtain additional equation:

V_{g}I_{g}=VI (5)

From (6), (7), and (8) we can solve for output DC voltage V and DC voltage V_{C} of capacitor C:

V=DV_{g} (6)

V_{C}=0 (7)

A rather interesting result is obtained: steady-state DC voltage V_{C} of capacitor C is always zero for any duty ratio D. Furthermore, the DC conversion gain is the linear function of duty ratio as illustrated by equation (9) and graph in FIG. 12c.

To complete the waveform analysis one needs to solve the resonant circuit formed by capacitor C and resonant inductor Lᵣ during OFF time interval. However, the solution is identical for the polarity-inverting converter of FIG. 7b, so we will defer the resonant solution for later section.

### DC Analysis of Polarity-inverting Converter

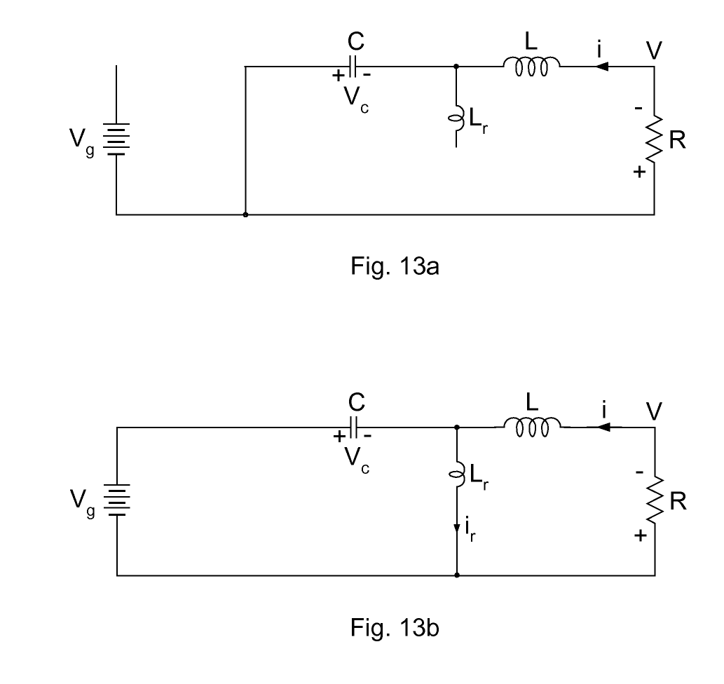

The two switched circuits, for square-wave interval and resonant interval for the polarity-inverting converter of FIG. 7b are shown in FIG. 13a and FIG. 13b respectively. Note that in this case, the input current is a resonant current iᵣ, which is sinusoidal-like and must be evaluated first if the 100% efficiency argument is to be used. Therefore, to find DC properties, the general method of analysis is used, the state-space averaging method described in (1).

We now apply the state-space averaging method for both intervals and obtain the following equations:

Square-wave interval DT_{S}:

$$\begin{matrix}L \frac{d i}{d t} = {v}_{C} - v & ( 8 ) \\ {L}_{r} \frac{d {i}_{r}}{d t} = 0 & ( 9 ) \\ C \frac{d {v}_{C}}{d t} = - i & ( 10 )\end{matrix}$$

Resonant interval D′T_{S}:

$$\begin{matrix}L \frac{d i}{d t} = - {V}_{g} + {v}_{C} - v & ( 11 ) \\ {L}_{r} \frac{d {i}_{r}}{d t} = {V}_{g} - {v}_{C} & ( 12 ) \\ C \frac{d {v}_{C}}{d t} = {i}_{r} - i & ( 13 )\end{matrix}$$

Following state-space averaging method, we take the weighted average of the two sets of equations, with the weighting factors D and D′ respectively to obtain the dynamic model which could be used to evaluate frequency response characteristics of this converter. For the special case of evaluation of DC quantities we equate the right hand side to zero. All time domain quantities become average DC quantities marked with corresponding capital letters so we get equations for steady state (DC):

V_{C}−V−D′V_{g}=0 (14)

D′(V_{g}−V_{C})=0 (15)

−I+D′I_{R}=0 (16)

Solution is:

V=D′V_{g} (17)

V_{C}=V_{g} (18)

I=D′I_{R} (19)

Once again the same linear DC conversion gain (20) is obtained as for non-inverting converter. The average input DC current is then given by:

I_{g}=D′(I_{R}−I) (20)

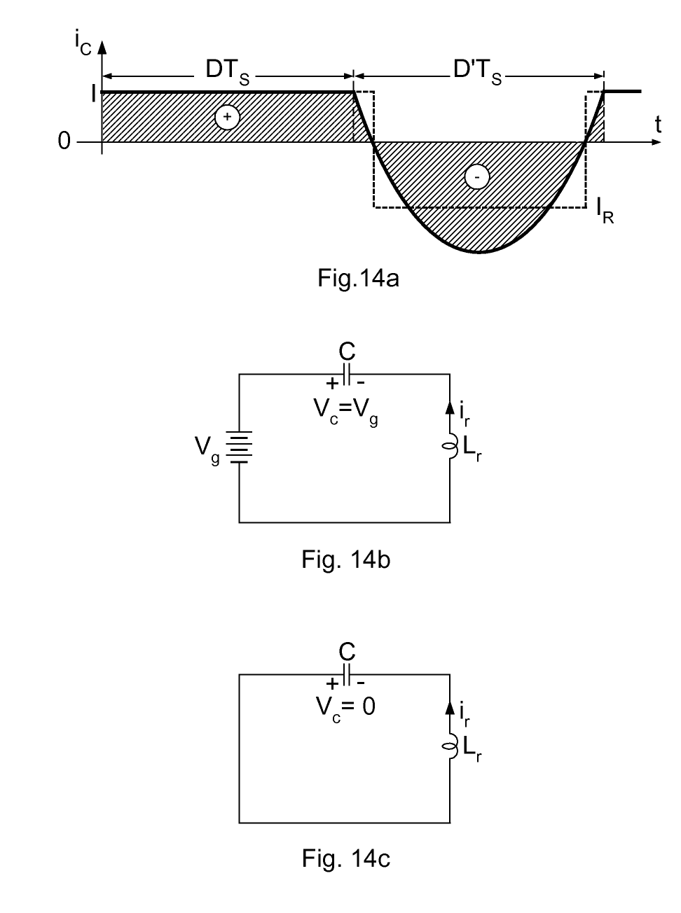

Note that the state-space averaging is in the above description extended to handle even the resonant current waveforms, even though the original method was, obviously not considering those cases as the Hybrid-switching method did not exist. The above example illustrates with the help of FIG. 14a how this extension of the method is made. In above averaged equations we have introduced one quantity, which was not defined yet: the average resonant current I_{R}. FIG. 14a shows the capacitor C current i_{C}, which clearly shows square-wave like charging current and resonant, sinusoidal like discharging current. As the charging and discharging areas must be identical since no net DC charge over a single period is a prerequisite for a steady state (no increase of its DC voltage on cycle by cycle basis). Therefore, the area of the sinusoidal like discharge must be equal to an equivalent square-wave like current with magnitude I_{R} as depicted in graph of FIG. 14a.

### Hybrid-Switching Conversion

Note that the voltage V_{C} on capacitor C is no longer zero but equal to input DC voltage as shown by (21). This is significant, because the resonant circuit appears to be more complex as it consist of the series connection of capacitor C and input DC voltage source V_{g} as shown in FIG. 14b.

However, because their DC voltages subtract exactly, the resonant circuit could be simplified to that of a single capacitor C, which now has an effective DC voltage V_{C}=0 and only operates with small ripple voltage on capacitor C. Therefore, the resonant circuit reduces to the same resonant circuit as for the non-inverting converter of FIG. 7a. This also illustrates one significant advantage of the hybrid switched-mode power conversion and a unique way the resonance is taking place in hybrid conversion. In true resonant converters the original square-wave voltage waveforms are distorted by resonance into sinusoidal waveforms with much larger peak values, resulting in much increased voltage stresses on switches. Here despite a large sinusoidal currents, the resonance does not effect to the first order the voltage stresses on the switches, as the resonance only effects the ripple voltage on capacitor C (changes them from linear to sinusoidal) thus, preserving original low voltage stresses on all switches.

### Small Size of Resonant Inductor

Note also how the Hybrid-switching method results in very small size of resonant inductor. The AC voltage across resonant inductor is equal to a ripple voltage Δv across the capacitor C that is typically 20 times smaller then the sustaining DC voltage V_{C}:

Δv=0.05V_{C} (21)

Therefore, the resonant inductor Lᵣ will be much smaller than the main output inductor L and also have correspondingly much less stored energy.

It is this ripple voltage Δv on capacitor C which is actually exciting the resonant circuit when the switch S′ is turned ON during OFF-time interval D′T_{S}. We are now in a position to complete the analysis by deriving the analytical expressions for the resonant current and resonant voltage during the resonant interval.

### Analysis of the Resonant Circuit

We now analyze the resonant circuit shown in FIG. 15a. This second order resonant circuit can be described analytically by set of two cross-coupled first order differential equations described by:

Cdv_{c}/dt=iᵣ (22)

Lᵣdiᵣ/dt=v_{c} (23)

FIG. 15a shows that the capacitor C has a voltage Δv at the beginning of resonant interval. The capacitor C current is shown in FIG. 15b with shaded areas indicating equal positive and negative charge on capacitor C. FIG. 15c illustrates the diode rectifier current i_{CR}. As seen from FIG. 15d, the capacitor C was being charged during ON-time interval by a constant current source I leading to linearly rising ripple voltage, which at the end of ON-time interval is equal to Δv. As resonant inductor was not conducting during ON-time interval, initial resonant current is zero and initial conditions are:

vᵣ(0)=Δv (24)

iᵣ(0)=0 (25)

Solving (22) and (23) subject to initial conditions (24) and (25) results in the solution given by:

$$\begin{matrix}{i}_{r} ( t ) = {I}_{P} sin ( {ω}_{t} t ) & ( 26 ) \\ {v}_{r} ( t ) = Δ v cos ( {ω}_{r} t ) & ( 27 ) \\ Δ v = {I}_{P} {R}_{N} & ( 28 ) \\ {R}_{N} = \sqrt{\frac{{L}_{r}}{C}} & ( 29 )\end{matrix}$$

where R_{N} is the natural damping resistance and

$$\begin{matrix}{ω}_{r} = \frac{1}{\sqrt{{L}_{r} C}} \\ and & ( 30 ) \\ {f}_{r} = {ω}_{r} \text{/} 2 π \\ and & ( 31 ) \\ {T}_{R} = 1 \text{/} {f}_{r} & ( 32 )\end{matrix}$$

where fᵣ is the resonant frequency and T_{R} is the resonant period.

The initial voltage Δv at the beginning of resonant interval can be calculated from input inductor current I_{L} during DT_{S} interval in FIG. 11b as:

$$Δ v = \frac{1}{2} \frac{{I}_{L} {D}^{′}}{{Cf}_{s}} \qquad ( 33 )$$

Substitution of (28) and (29) into (33) results in

I_{P}=ID′πfᵣ/fₛ (34)

For simplicity, and without loss of generality, we assumed that the output inductor L is so large that its current can be represented by a constant current source I.

The capacitor current i_{c} during resonant interval is then described by:

i_{c}=I−I_{P} sin(ωᵣt) (35)

and shown graphically as in FIG. 15b. Note once again that the two areas are shown shaded to emphasize their equal areas, as the net charge on capacitor over full cycle is zero under steady state conditions. Note also that FIG. 15b shows a special case when the resonant interval is equal to OFF-time interval, so that the diode current returns to zero just at the end of switching cycle. Clearly, when diode current reaches zero current level it will turn-OFF. There is apparently no problem in voltage overshoot on resonant inductor at the turn-OFF instant since the current is zero. Thus, this justifies the premise made at the beginning that the resonant inductor in the switch branch is allowed and will cause no problems.

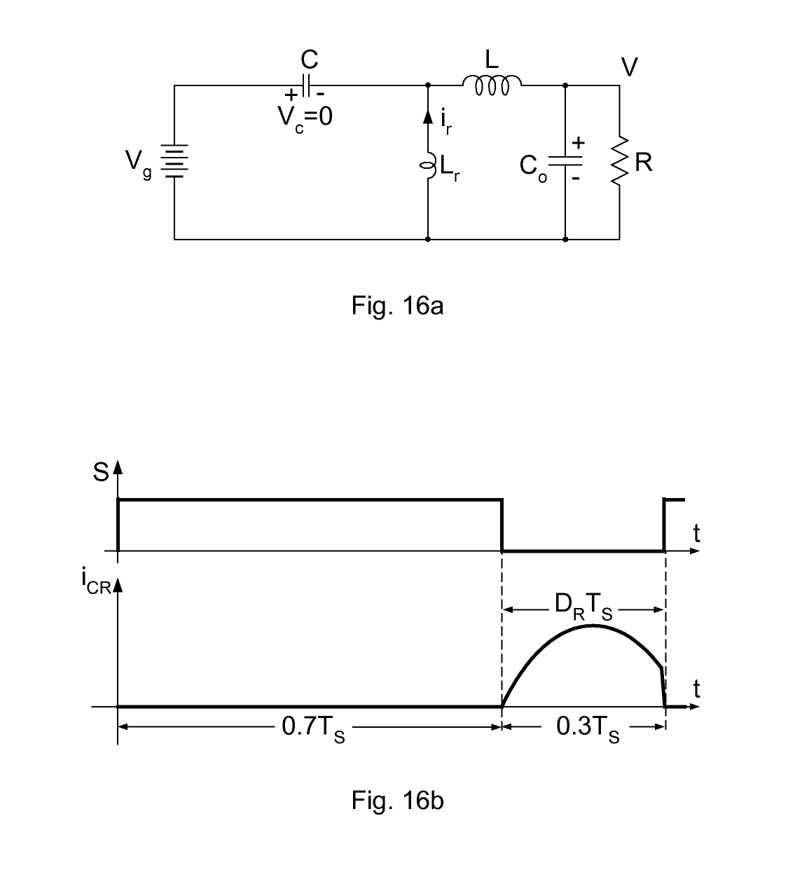

However, what about the case when there is indeed the finite non-zero current in the diode branch at the moment of turn-OFF of switch S′. In that case, the turning OFF of switch S′ will NOT turn-OFF the current in the diode and the diode current will continue to flow because the circuit in FIG. 16a is obtained with switch S turned-ON. For the converter of FIG. 16a a large DC voltage V_{g} directly across the resonant inductor would result in a fast discharge of the current remaining in resonant inductor to zero with a slope of V_{g}/Lᵣ as illustrated in FIG. 16b. Clearly once zero current is reached, the current rectifier will turn-OFF. This now fully explains why the placement of the resonant inductor in diode branch is allowed under all operating conditions in the converters of present invention operating with hybrid switched-mode conversion. This is clearly not allowed in either square-wave or conventional resonant converters.

The condition encountered in the above case is when:

D_{R}>1−D (36)

where D_{R} is the resonant duty ratio.

We now look into several different methods by which the output voltage can be controlled and regulated.

Duty Ratio Control with Constant Switching Frequency

To investigate various modes of control a low power experimental converter was made operating under the following conditions: V_{g}=24V, I=0.5 A

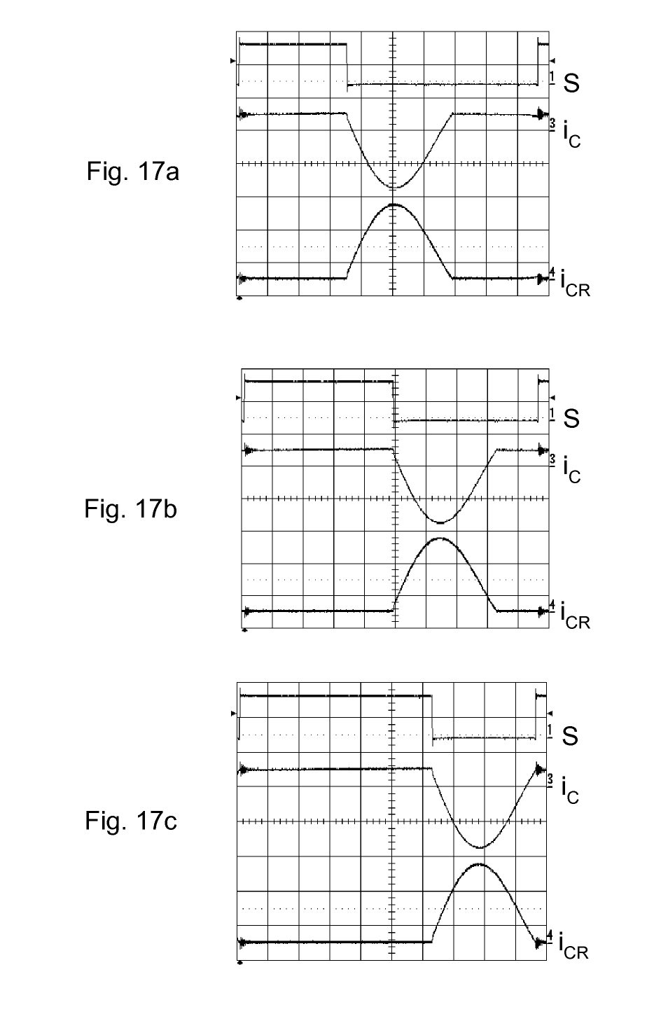

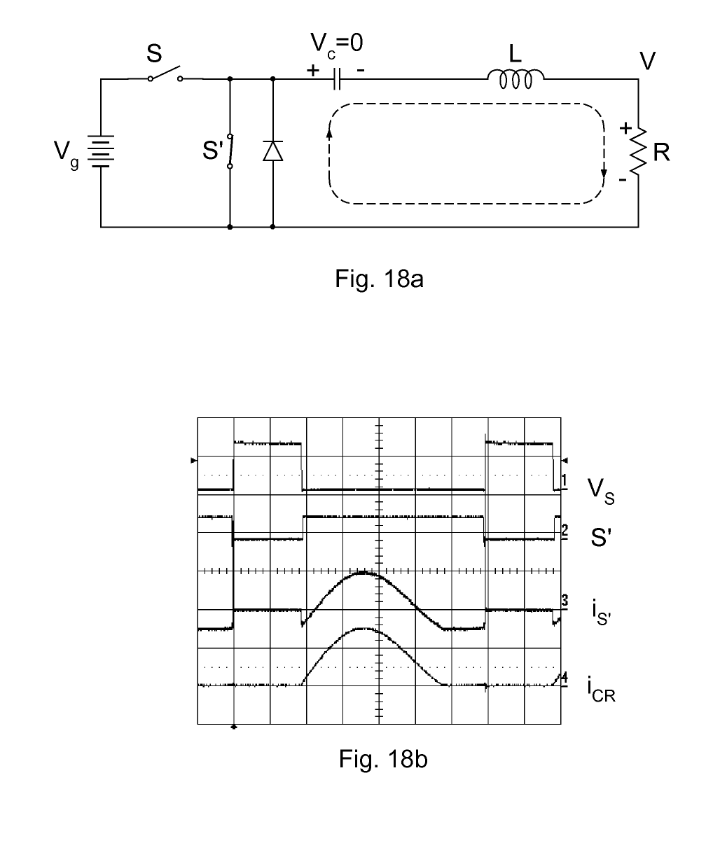

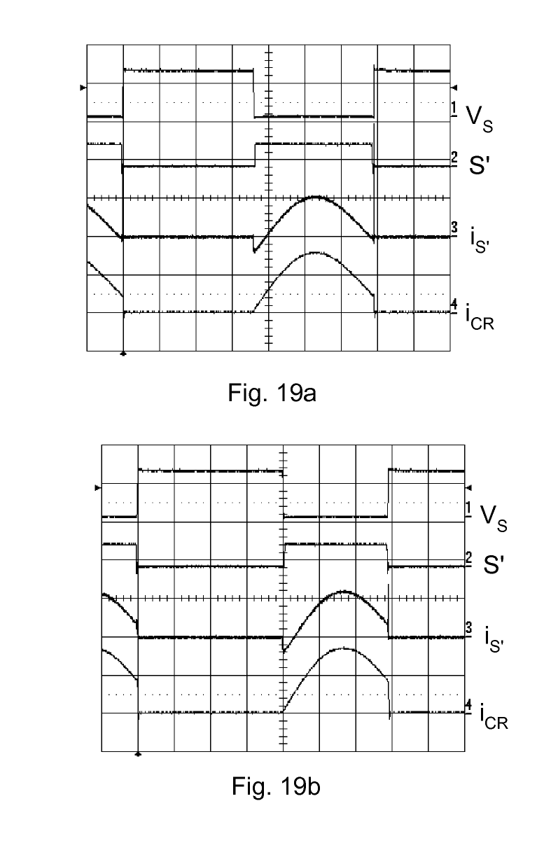

First a constant switching frequency of f_{S}=20 kHz is chosen. Also resonant components are chosen so that D_{R}=0.33. The salient waveforms for three different operating points, D=0.33, D=0.5 and D=0.66 are shown in FIGS. 17a-c. The salient waveforms include from top to bottom: state of switch S, capacitor C current and diode CR current. The resulting output voltages are shown in Table 1 below, which confirms DC gain to be a linear function of duty Ratio D. Note, how the diode current is unchanged and only the beginning of resonant interval is moved with the increased duty ratio D. This seemed rather odd considering that increased duty ratio would result in more total charge on capacitor C, hence in higher total discharge and hence higher magnitude of the discharge current during the resonant interval which is fixed at D_{R}=0.33. However, the look at the circuit of FIG. 18a explains what is taking place. Although switch S is turned OFF and it appears that any further charge of capacitor C is prevented for the rest of the OFF-interval, this is not the case. Note that the switch S′ is implemented as a current bi-directional switch having an anti-parallel diode, which is capable of conducting the current in opposite direction. Thus, when the resonant current flow stops, MOSFET switch S′ is still able to conduct the load current which continues to charge capacitor C although not through switch S but instead through the body diode of switch S′. Second trace in FIG. 18b shows that S′ switch is turned-ON during entire D′T_{S} interval, while the current through it changes direction. This is further confirmed by the current waveform of the switch S′ which shows the capacitor C charging takes place even after diode CR current i_{CR} is turned OFF as illustrated by the fourth trace in FIG. 18b. Thus, total charging interval is, in fact, constant and equal to 0.66 irrespective of the actual duty ratios D of 0.33, 0.5 or 0.66 as displayed in FIGS. 17a-c. Actually, the output inductor first circulates its current through the output diode CR and then after it stops conducting, it circulates its current through the body diode of the switch S′. By operating this switch as a synchronous rectifier one could reduce these additional conduction losses by using low ON-resistance of MOSFET to bypass conduction through its body diode. At some higher duty ratio the conditions are obtained as in FIG. 19a showing that switch S′ can be also turned-OFF at zero current with the reduced turn-OFF losses. In that case the load current is again conducted through the current rectifier CR. Finally, at yet higher duty ratio shown in FIG. 19b both switch S′ and diode CR are turned OFF with the fast slope discharge as discussed before with reference to FIG. 14c. However, the better and more efficient way is to eliminate the conduction losses of switch S′ after diode CR is turned OFF by implementing one of the two more efficient control and regulation methods described below which effectively eliminate this additional conduction interval.

TABLE 1

| | Duty Ratio D | | | |
|---|---|---|---|---|
| | 0.36 | 0.5 | 0.65 | 0.715 |
| Output Voltage V [V] | 7.68 | 11.1 | 14.7 | 15.77 |

Duty Ratio Control with Constant OFF-Time

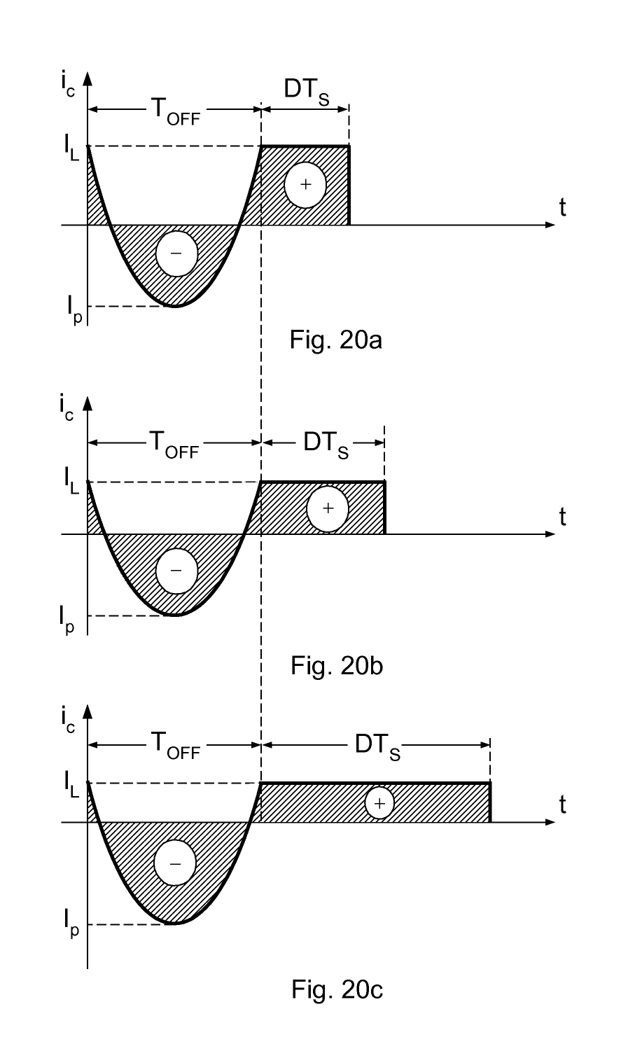

As the resonant interval T_{OFF}=D_{R}T_{S} is constant and determined by the choice of the resonant components, it is quite natural to chose this OFF-time interval to be constant, and to exercise the control of output voltage by varying the ON-time interval DTₛ as illustrated in graphs of FIGS. 20a-c, for three duty ratios D=0.33, D=0.5 and D=0.66. Note that the OFF-time interval is displayed first, to emphasize the constant OFF-time, while the variable ON-time clearly results in corresponding variable switching frequency. Thus, we have both variable switching frequency and variable ON-time or equivalently variable duty ratio D as before. Note, however, that as in analysis of constant switching frequency converters with variable duty ratio, the steady-state conversion properties are still only a function of the duty ratio and do not depend on switching frequency. In fact, the same steady-state DC properties are maintained as derived in previous analysis for constant switching frequency of operation.

In this operation, the OFF-time is kept constant as per equation:

T_{OFF}=(1−D)T_{S}=Tᵣ/2=constant (37)

Hence, both duty ratio D and switching frequency must be variable in order to preserve relationship given by (37). Solving (37) for duty ratio results in:

D=1−f_{S}/2fᵣ (38)

Thus, voltage regulation is obtained by use of the variable switching frequency f_{S}. However, this results in corresponding duty ratio D as per (38). Note that all DC quantities, such as DC voltages on capacitors and DC currents of inductors are still represented as a function of duty ratio D only, as in the case of conventional constant-switching frequency operation.

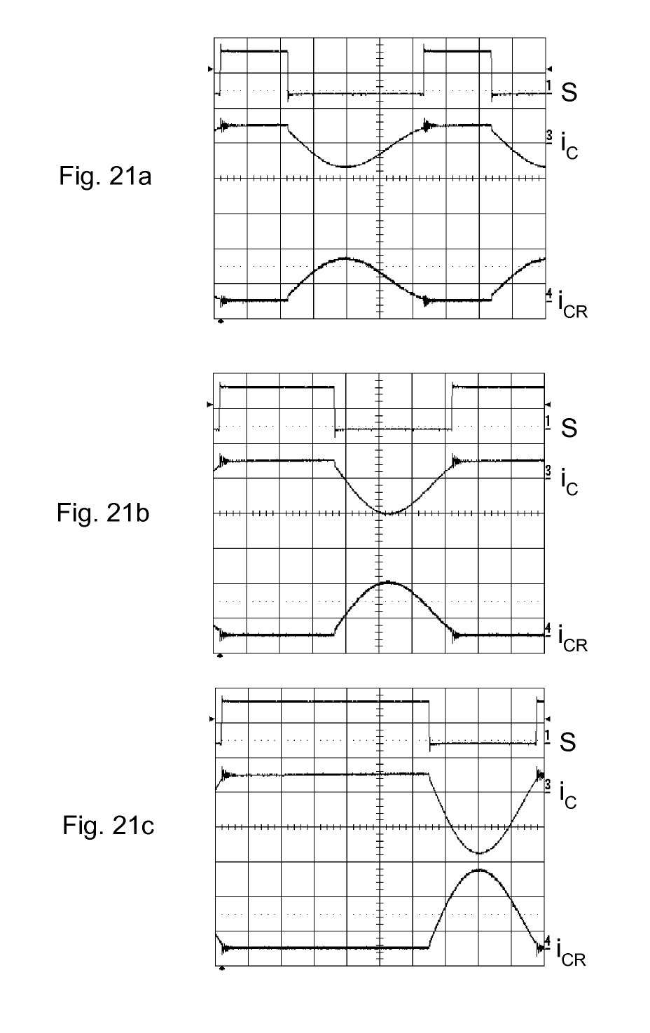

The same experimental circuit is used now but with variable duty ratio and variable switching frequency to result in waveforms displayed in FIGS. 21a-c. The corresponding measured DC output voltages for three duty ratios and the corresponding variable switching frequencies are shown in the Table 2.

TABLE 2

| | Switching frequency f_{S} [kHz] | | |
|---|---|---|---|
| | 21.0 | 27.5 | 32.0 |
| Output Voltage V [V] | 10.82 | 10.99 | 11.10 |

Note that despite the 2:1 change in duty ratio from 0.66 to 0.33, the corresponding switching frequency is increased approximately only 50% from 21 kHz to 32 kHz as per equation (38).

### Resonant Circuit Analysis Under Constant OFF-Time Operation

The capacitor C current waveforms in FIG. 20a, FIG. 20b and FIG. 20c are shown for three different duty ratios and corresponding switching frequencies. Note that the resonant inductor current is the same as the capacitor C current during the DT_{S} interval. Since capacitor C current must be charge balanced, the areas shown shaded must be equal in all three cases of different duty ratios. Clearly, this condition imposes a quantitative relationship between the peak value Iₚ of the resonant current and load current I. Substitution of (19) into (14) results in:

I_{P}=(Iπ/2)(D′/D) (39)

for all duty ratios in general. For a special case of 50% duty ratio:

I_{P}=Iπ/2 (40)

This is illustrated by the capacitor current waveform in FIG. 20b. Note that this is the same relationship needed to insure that the two shaded areas in FIG. 20b are equal for a 50% duty ratio thus independently confirming the above general analysis. This also confirms an important practical result. The capacitor's rms current is only 11% higher than the rms value of the square-wave like current, which has minimum rms value.

### Duty Ratio Control and Variable Resonant Interval

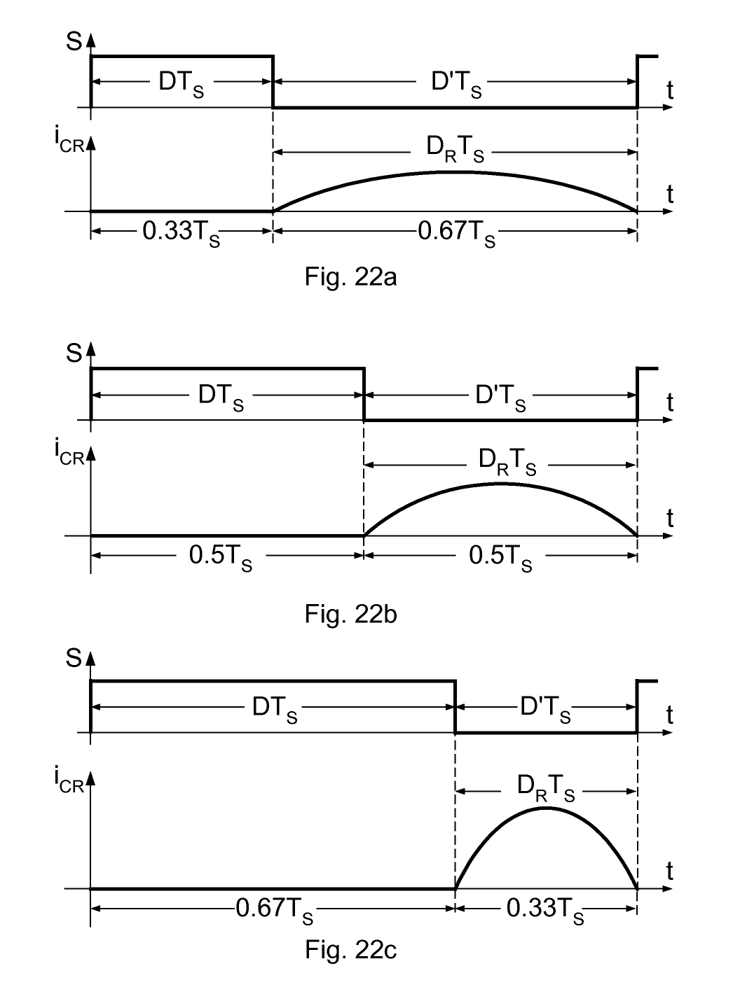

The above ideal operation with diode current turning ON and OFF at zero current level and efficient operation is actually possible even when the switching frequency is kept constant. However, one must in that case adjust the resonant interval D_{R}T_{S} to be always equal to the OFF-time, or alternatively to have for each duty ratio D corresponding matching complementary duty resonant duty ratio D_{R} as displayed in FIGS. 22a-c: for D=0.33, D_{R}=0.66, for D=0.5, D_{R}=0.5, and for D=0.66, D_{R}=0.33 so that

D_{R}=1−D (41)

This could be accomplished by changing for example, either the capacitor values or resonant inductor values. Although simply varying the air-gap could change resonant inductor values, this clearly mechanical approach would not work. However, there is an electronic alternative, which could be implemented using standard well-known means of varying inductor values by use of the saturable reactors. Then by varying the DC current of one winding one can directly change quickly the resonant inductor value and thereby change the respective resonant duty ratio D_{R} to match the one needed by duty ratio D of the main switch to satisfy the boundary condition (37).

### Stressless Switching

The best mode of operation is as shown in FIGS. 20a-c or FIGS. 22a-c when the resonant discharge interval (half of the resonant period) is equal to the OFF-time switching interval. In that case, in addition to lowest conduction losses, the current rectifier CR turns OFF under ideal conditions of zero current eliminating undesirable and large turn-OFF losses associated with the reverse recovery current losses which are especially prevalent in applications with higher output voltages.

The best mode of operation insured several distinct advantages:
1. Most efficient operation with minimum conduction losses is obtained;
2. The output current is switched under ideal conditions:
   a) Turn-ON of the current rectifier switch with zero voltage and zero current;
   b) Turn-OFF of the current rectifier switch with zero voltage and zero current eliminates turn OFF losses.

The absence of the complementary secondary side switch is very desirable as the cross conduction and spike problems present in conventional converters are eliminated naturally by the fundamental operation of the converter. Clearly, the single diode switch has no switching losses, neither turn-ON losses nor turn-OFF losses. Because of the ideal switching characteristics of the diode switch, which go well beyond just switching loss reduction of the prior-art converter, this method of elimination of switching losses and other undesirable stresses (spikes, etc) is appropriately termed stressless switching.

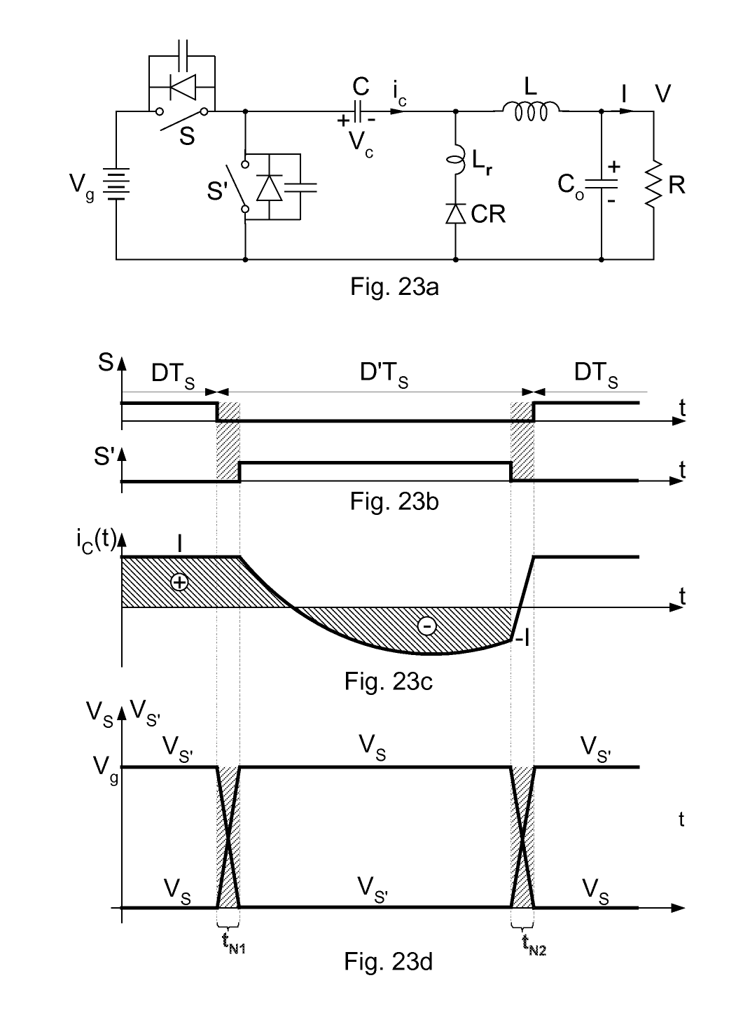

With the switching losses and switching stresses completely eliminated from the current rectifier CR let us now see how we can also eliminate the switching losses from the two active switches S and S′ which operate out of phase. For that purpose, the MOSFET switches of the converter in FIG. 8a are each modeled as shown in FIG. 23a with an ideal switch in parallel with the diode (simulating body diode of MOSFET) and a capacitor modeling the drain to source parasitic capacitance of each switch. The first step toward elimination of switching losses is to provide the two transition intervals t_{N1} and t_{N2} as designated in FIG. 23d during which both switches are turned-OFF as illustrated by their switch states in FIG. 23b.

In the present invention there is no need for high output inductor ripple current to obtain zero voltage switching. Here such polarity-changing current is already available in the form of the capacitor C current illustrated in FIG. 23c. At the beginning of first transition the positive charging current of capacitor C is equal to DC load current I discharging the parasitic capacitor of S′ switch causing also the linear reduction of its voltage to zero at which point its body diode turns ON the switch at zero switching losses (see FIG. 23d). The discharge energy is transferred to the parasitic capacitor of the switch S. After capacitor C has undergone discharge during resonant interval to the point that it now has a negative current equal to −I, by turning-OFF the switch S′ the opposite transfer of energy takes place between two parasitic capacitors during second transition. This time the parasitic capacitor of switch S is being discharged and its voltage reduced to zero at which point its body diode is turned ON thus turning the switch S at zero voltage with zero switching losses as in FIG. 23d.

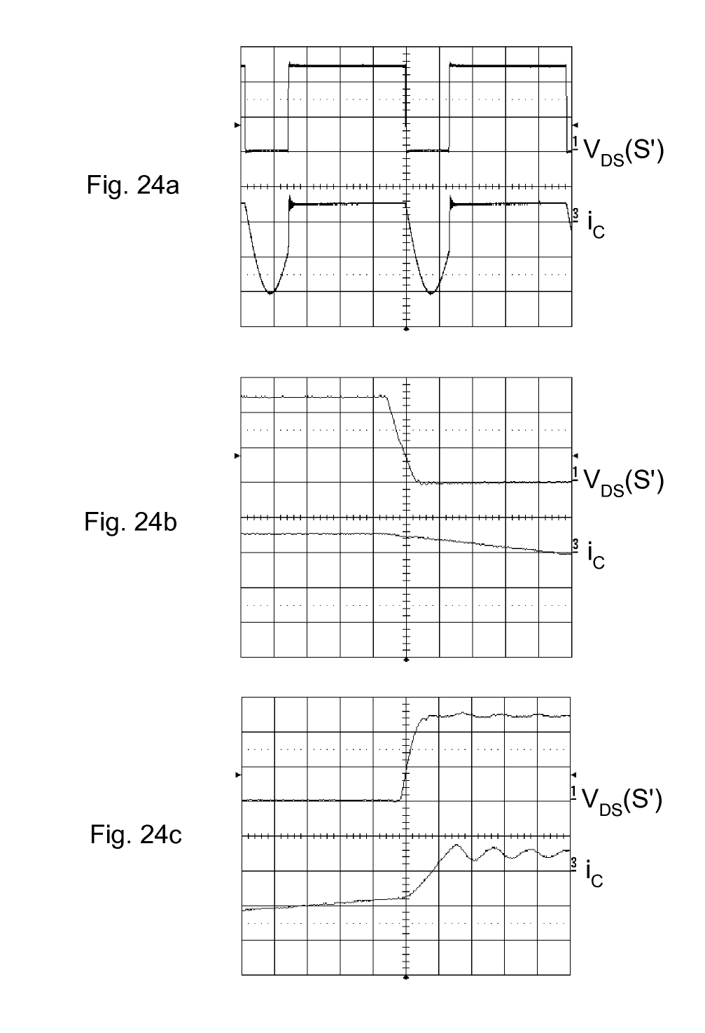

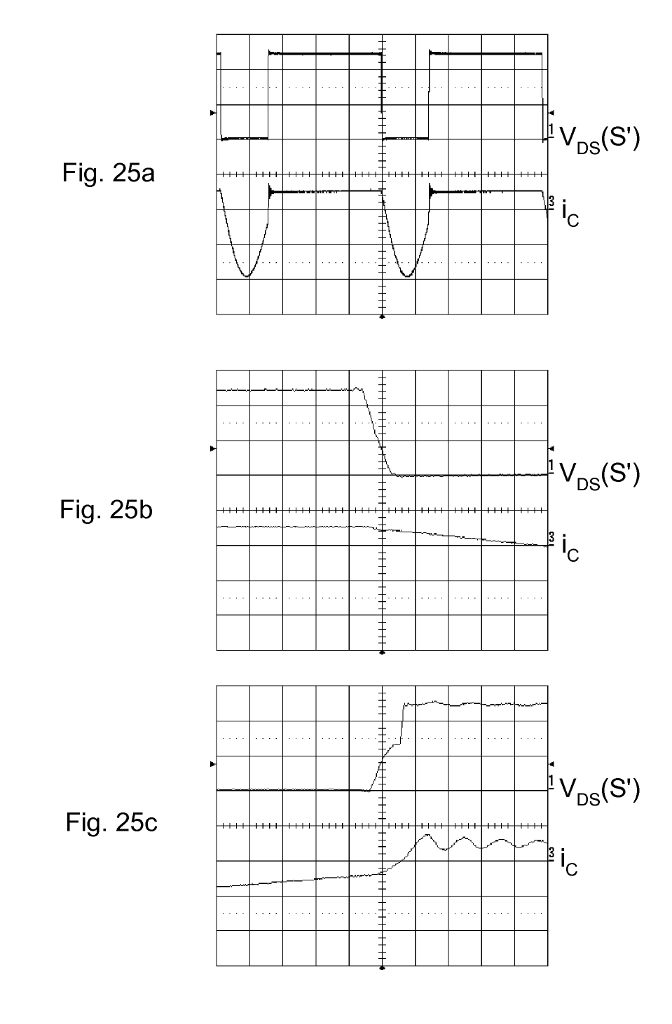

The stressless switching of the two switches is confirmed experimentally on the same converter used to illustrate various control methods in previous sections. The experiment is conducted for full load current and at 50% load current. Top trace on FIG. 24a shows the drain to source voltage of the switch S′, while the bottom trace shows the capacitor C current. The first transition (D to D′) is shown enlarged on FIG. 24b and top trace confirms the linear discharge of the drain to source voltage of switch S′ and zero voltage turn-ON. The second transition is shown enlarged on FIG. 24c displaying fast rise of the drain to source voltage of S′ switch and its turn-OFF at peak voltage with no voltage overshoot. The parasitic capacitor of switch S is therefore discharging fast and turning-ON at zero voltage. FIG. 25a reinforces the switching loss reduction at 50% load, except this time, the first transition has full discharge to zero voltage (FIG. 25b) while the second transition (FIG. 25c) that switch S has only partial lossless discharge and still some hard switching losses as the reverse current was not sufficient for full zero voltage switching.

### Other Non-isolated DC-DC Converter Embodiments

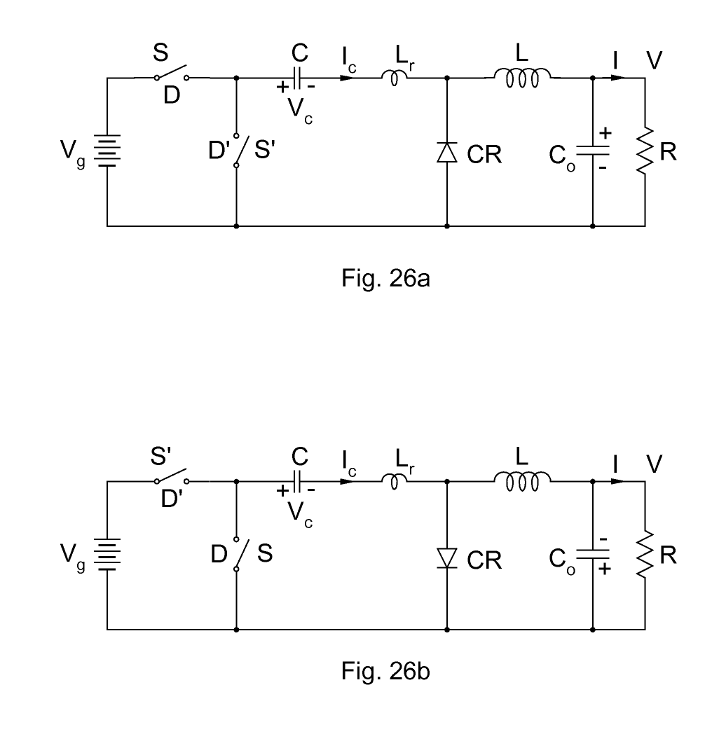

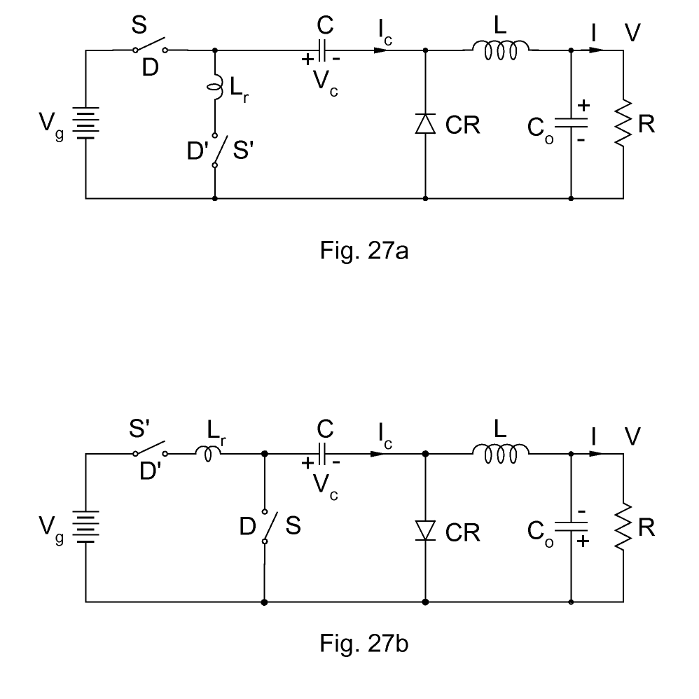

The two embodiments of present invention, shown in FIG. 7a and FIG. 7b, had the resonant inductor placed in the diode branch. However, the resonant inductor could be moved to the capacitor C branch as in FIG. 26a to create polarity non-inverting converter with essentially the same performance. For example moving the resonant inductor from the diode branch through the node connecting capacitor C and output inductor, the resonant inductor in capacitor branch would be generated. The added small resonant inductor in series with large output inductor would have only second order effect on the performance. The key is that the resonant circuit analysis would be the same as derived earlier. However, there is one added advantage of placing the resonant inductor in capacitor C branch. We have shown earlier that capacitor C must be charged balanced in the steady state, which means that it cannot pass any average or DC current over one cycle period. This in turn confirms that the resonant inductor when placed in this branch will have no DC bias and will be designed as an AC small value resonant inductor. This should be contrasted to the requirement for resonant inductor when in diode branch, where it must be designed considering that it has substantial DC bias, equal to DC load current. The above analysis applies equally well to the polarity-inverting configuration of FIG. 26b. Two other possible placements of the resonant inductor are also shown in FIG. 27a and FIG. 27b but with possibly inferior performance. Both are in the branch with main switch and their turn-OFF might cause large, but narrow spikes of the kind discussed with reference to FIG. 10c and FIG. 10d. Nevertheless as the energy stored in the resonant inductor is rather negligible (two order of magnitude below that stored in output inductor for example), a transorber could be used to limit the turn-OFF spike voltage. Each of the four converters in FIGS. 26a-b and FIGS. 27a-b have also their isolated equivalents analyzed in more details in next section.

### Detailed Analysis of the Isolated DC-DC Converters

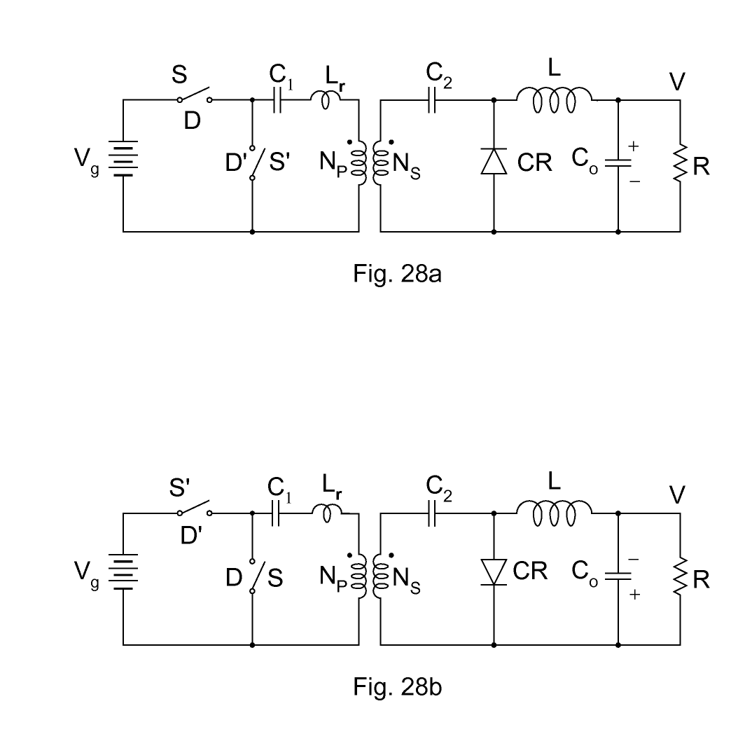

Of particular practical interest are the isolated extensions of the converters in FIG. 26a and FIG. 26b shown in FIG. 28a and FIG. 28b respectively. The resonant inductor can be placed in either primary side or secondary side. However, since the secondary side is usually low voltage high current, the primary side is preferred, as resonant inductor would be designed for the low current. An added advantage is that the resonant inductor is then also in the position identical to that of the transformer leakage inductor. Since the leakage inductor is usually rather small and on the same order as the resonant inductor, the converter practical implementation can be further simplified by, in fact, eliminating entirely the resonant inductor. The role of resonant inductor would then be taken over by the built-in leakage inductance of the isolation transformer. The drawback is that this would also impose an additional constraint on the design, as the resonant inductor value could not be chosen to optimize design.

For the application when the isolation transformer has a large step-up turns ratio, such as when low input voltage of 30V from solar cells is stepped up to 400V DC peak for DC-AC inverter of FIG. 3a the resonant inductor may be placed in the high voltage secondary side. In that case, the high leakage inductance on the secondary side may also play the role of the resonant inductor.

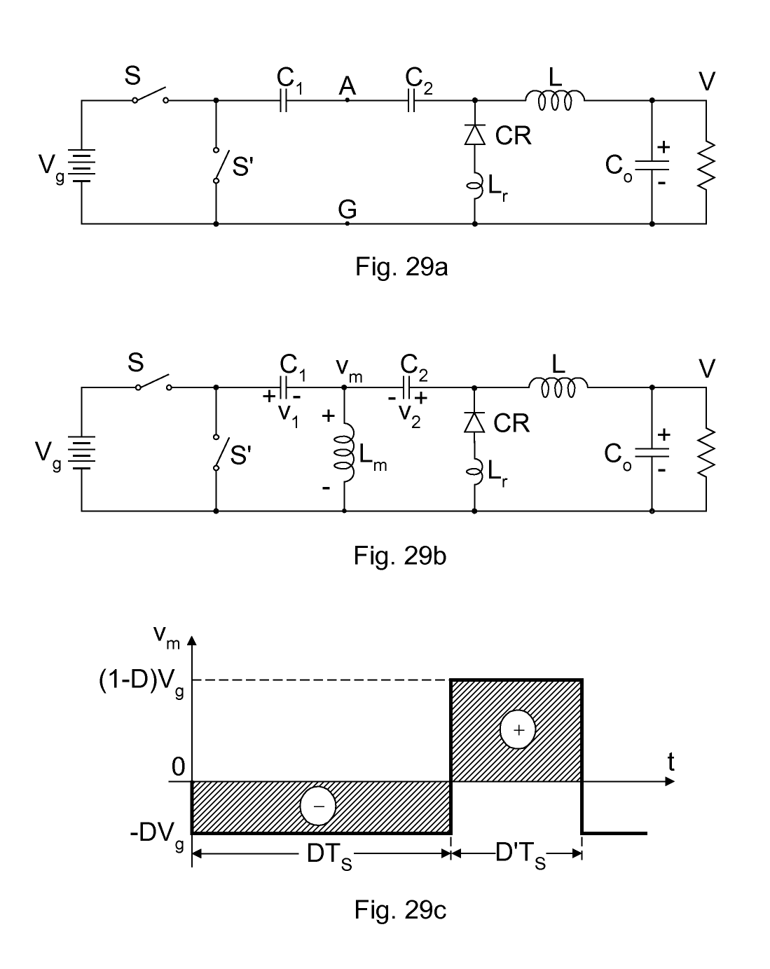

We now go back to the original position of the resonant inductor in the branch with the diode CR as illustrated in FIG. 29a. By splitting the capacitor C of FIG. 7a into two capacitors C₁ and C₂ in series as in FIG. 29a leads to natural placement of the transformer magnetizing inductance Lₘ between nodes A and G such as in FIG. 29b. By the very placement of the inductor Lₘ it cannot have any DC bias, due to capacitive coupling from both sides. Therefore, the respective transformer replacing the magnetizing inductance would have no DC current bias and no DC energy storage. We could determine the steady-state values of capacitors C₁ and C₂ needed by writing two sets of volt-second balance equations, one for ON-time interval, and another for OFF-time interval. However, there is a shorter and more revealing method of their determination. Note that in the loop consisting of C₂, Lₘ, L, and C₀, the two inductors are effectively short for DC analysis. Thus, summation of the DC voltages in that loop imposes the following condition:

V₂=V=DV_{g} (42)

Hence, the secondary side energy transferring capacitor C must have the same voltage as output DC voltage for all operating condition. We also know that for OFF-time interval a resonant switched circuit will be formed with resonant inductor Lᵣ such that the net DC voltage in this resonant circuit must be zero, from which based on the adopted positive polarity voltages as in FIG. 29b:

V₁=V₂=DV_{g} (43)

From (42) and (43) one can now draw the transformer magnetizing inductance waveform as in FIG. 29c. Note how the presence of the resonant inductor Lᵣ does not in any way effect transformer volt-second balance shown in FIG. 29c, as it is directly determined by the two switches S and S′ and their out of phase drive and DC voltage on capacitor C₁. The same holds true for the output inductor L, which has the identical voltage waveform as magnetizing inductance Lₘ. This will be later on used as justification for coupling output inductor and transformer into an Integrated Magnetics structure.

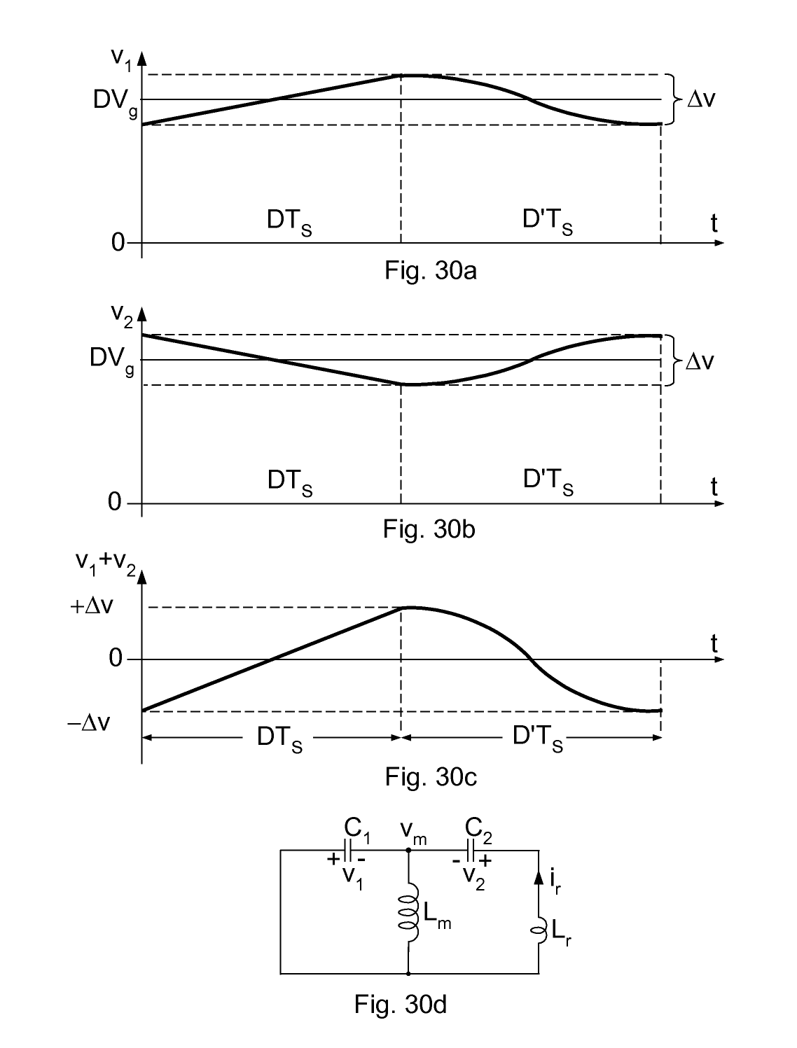

From (43), the DC voltages on two energy-transferring capacitors must be equal. However, their instantaneous voltages are not equal as illustrated in FIG. 30a and FIG. 30b. In fact, during ON-time interval the capacitor C₁ is charging linearly, while capacitor C₂ is at the same time discharging with opposite rate of discharge, so that at the end of ON-time interval, there is a net difference equal to the AC ripple voltage on this capacitance as illustrated in FIG. 30c. This ripple voltage Δv is initial voltage on capacitor at the onset of the resonant circuit operation of FIG. 30d.

Note that this ripple voltage Av is intentionally displayed large in FIG. 30a and FIG. 30b in order to clearly show the linear and sinusoidal change, where in practice this ripple voltage is only a fraction of the DC voltage V_{g}, as it represents typically only 5% to 10% of the DC value. The circuit model during the ON-time interval is again the resonant circuit of FIG. 30d. Note however, that despite large DC voltage level of each capacitor, the net voltage on two capacitors in series is their difference thus resulting in only an ac voltage mismatch of Δv as shown in FIG. 30c, which therefore leads to the same resonant converter analysis for the non-isolated converter derived before. Once again, the resonant inductor Lᵣ presence insures that the small ripple voltage difference Δv between two capacitors is not dissipated in a lossy manner but instead circulated in a lossless manner during the OFF-time interval. In addition, the resonance returns the capacitor value to the same one as at the beginning of ON-time interval. Clearly, the magnetizing inductance Lₘ in FIG. 29b can be replaced by a two winding transformer to result in the isolated step-down converter of FIG. 9a.

### Detailed Analysis of the Polarity-inverting Dc-DC Isolated Converter

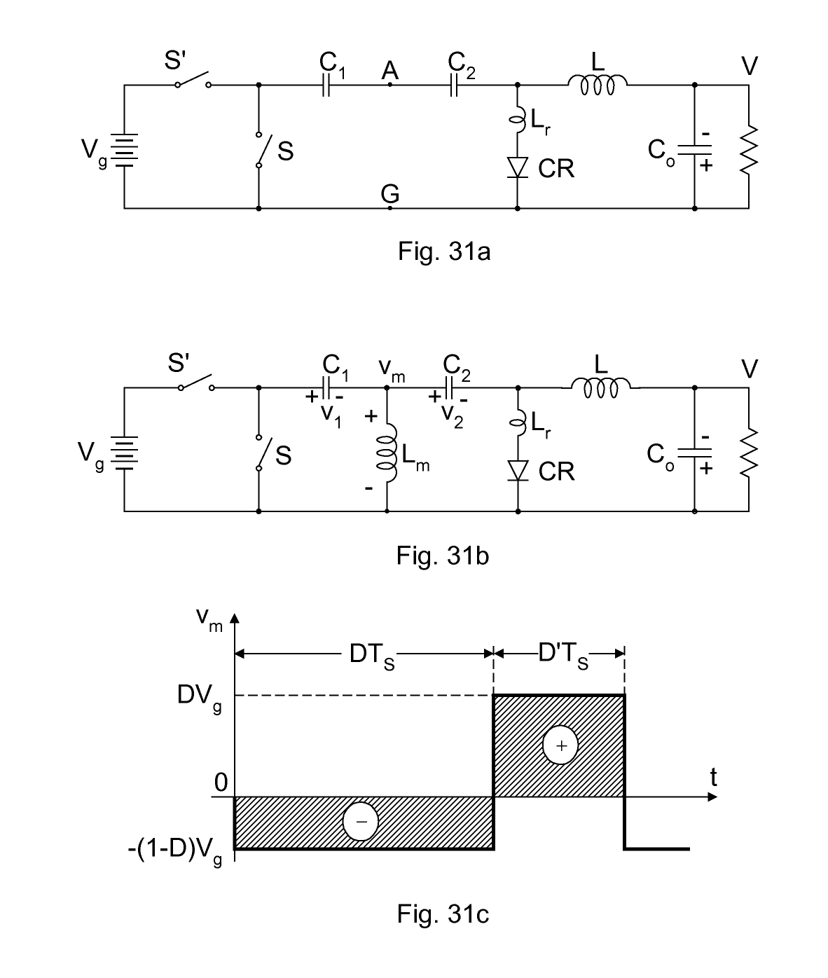

The isolation transformer is introduced into the polarity-inverting converter in the same way by splitting the capacitor C into two capacitors as in FIG. 31a and inserting a magnetizing inductance Lₘ as in FIG. 31b. Once again we follow a shorter and more revealing method for determination of the steady state values V₁ and V₂ of energy transferring capacitors C₁ and C₂.

The summation of DC voltages around the closed loop consisting of Lₘ, C₂, L and C₀, results in:

V₂=V (44)

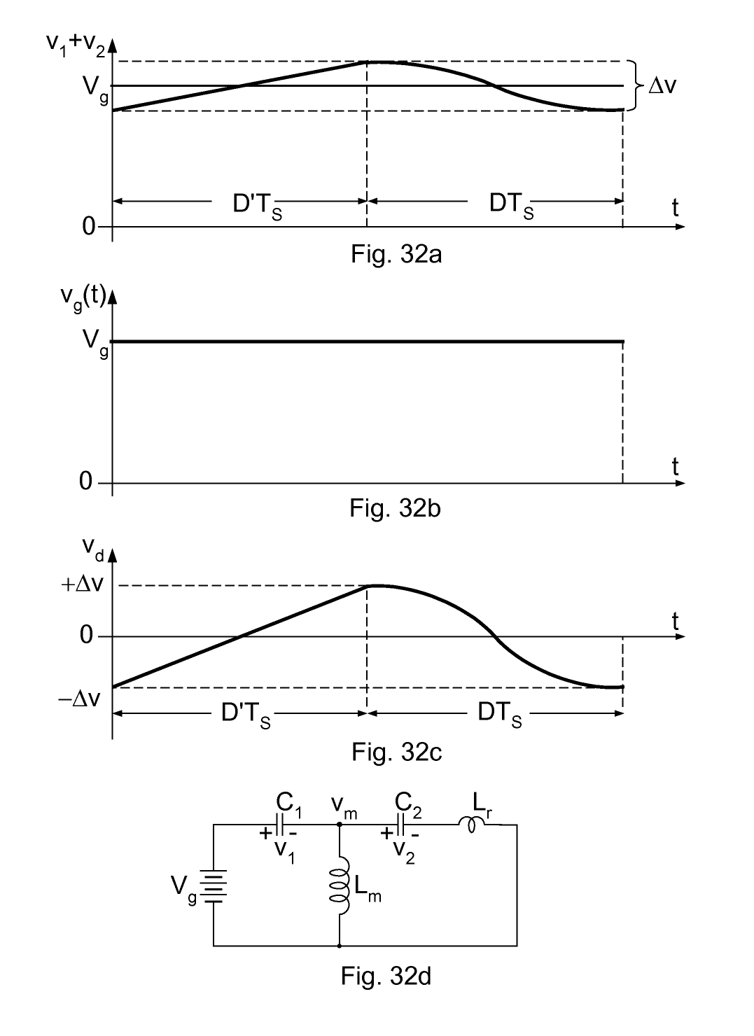

since the two inductors are effectively short for this DC analysis. The secondary side capacitor must be charged to the same DC voltage as the output DC voltage and have the polarity as indicated in FIG. 31b. Once again we can write a volt-second balance condition and determine the voltage V₁ on capacitor C₁ to be V₁=(1−D)V_{g}, which results in volt-second balance waveform displayed in FIG. 31c. Note that this results in the resonant circuit of FIG. 32d for the OFF-time interval for which:

V_{g}−V₁−V₂=0 (45)

Once again, the instantaneous sum of two capacitor DC voltages has the same DC value as the input DC voltage V_{g} as seen in FIG. 32a and FIG. 32b, which cancel to result in AC ripple voltage only as seen in FIG. 32c. Hence one prerequisite of hybrid-switching method is once again fulfilled and that is that the resonant circuit operates only with a net zero DC voltage and is excited only by the small ripple voltage Δv on capacitors as before and as shown in FIG. 32c.

### Isolation Transformer Advantages

All single-sided (non-bridge type on primary side) prior-art converters with step-down DC gain characteristic of D, resulted in a non-ideal transformer features such as:
1. DC energy storage in transformer such as Asymmetric Half-Bridge (AHB) converter;
2. Transformer whose excitation in the high duty ratio range results in very high reset voltage and correspondingly high voltage stresses on the switches as well as very limited input voltage range.
   The bridge-type converters on the other hand result in the use of four switches on the primary and four switches on the secondary side (higher conduction losses and cost) and in poor transformer winding utilization as the windings are for most part of the switching interval idling and not transferring any power to the load. This was the price paid to achieve their volt-second balance.

The present invention for the first time results in single-sided converter, which eliminates all of these problems as the isolation transformer operates as nearly ideal component:
1. No DC energy storage;
2. Full utilization of the windings;
3. Much lower flux density than comparable prior-art converters, thus resulting in substantially reduced magnetics size and decreased magnetics losses.

The first two advantages have already been highlighted. The third advantage is explained in more details in the next section.

### Transformer Size Comparisons

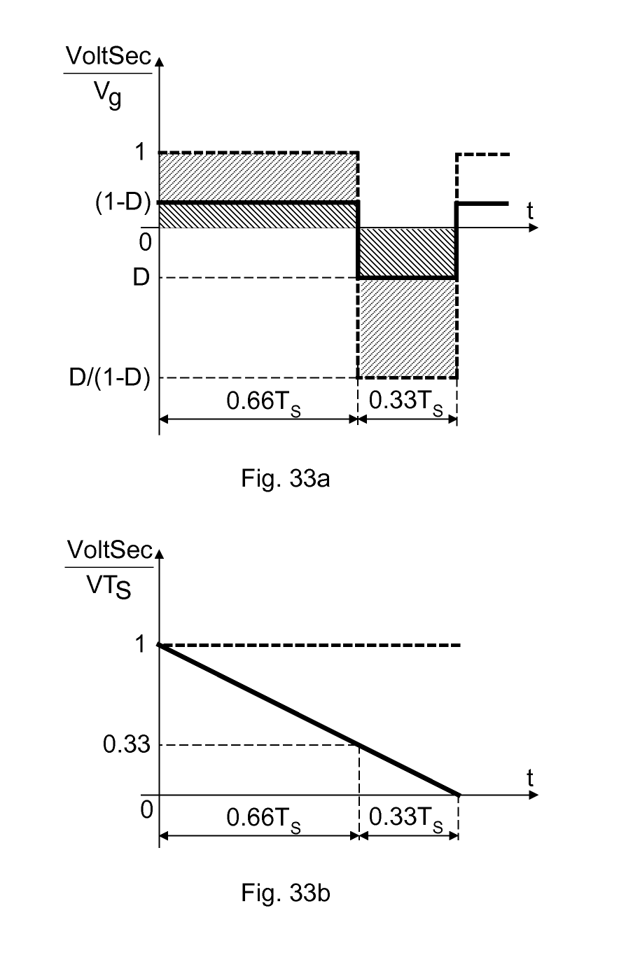

We will now compare the size of the key magnetics component, the isolation transformer, with the forward bridge typo DC-DC converters. Transformer voltage excitation in the two converters is illustrated in FIG. 33a: dotted lines are for forward converter and full lines are for present invention. Note how the increase of duty ratio excitation for the forward converter results in proportional increase of the volt-seconds, which with the reduction of reset time leads to very large reset voltages and ultimately too high stresses on switches.

Comparison at particular duty ratio of D=0.66 shown in FIG. 33a reveals direct effect on the size of the magnetics. The total Volt-seconds are three times bigger for forward converter than for the present invention, clearly resulting in three times larger flux density and more than 10 time larger core losses. On the other hand a core cross-section three times smaller could be used in present invention.

As the voltage excitation of the AHB is identical to present invention one would infer that it has the same size advantages. However, that is not the case, as the detailed analysis below reveals that it has the same size limitations as the forward converter. The reason for that is that one must evaluate the volt-seconds (VS) in terms of one common quantity, and that is output regulated DC voltage V.

Forward converter:VS=V_{g}DT_{S}=VT_{S} (46)

AHB converter:VS=(1−D)DV_{g}T_{S}=VT_{S} (47)

Thus, AHB converter appeared to have lower volt-seconds than forward converter due to product D(1−D). However, AHB converter DC voltage gain is:

V=D(1−D)V_{g} (48)

By replacing (48) into (47) the same constant volt-seconds are obtained which are directly proportional to regulated output DC voltage V.

On the other hand, the volt-seconds for present invention are:

VS=D(1−D)V_{g}T_{S} (49)

However, the DC voltage gain of the present invention is

V=(1−D)V_{g} (50)

Replacing (50) into (49) results in:

Present invention VS=(1−D)VT_{S}=VT_{S}/RF (51)

where the reduction factor is defined as;

RF=1/(1−D) (52)

and shows how many times is the flux in present invention reduced compared to that of prior-art converters. For example for D=0.66 illustrated in FIG. 33a and FIG. 33b the reduction factor is 3, so three times smaller core cross section could be used to result in much smaller magnetics size and further reduced losses, since smaller core has less total volume and proportionally less core loss. Similarly, smaller core results in lower winding length hence lower copper losses as well. Thus, both much smaller size and more efficient magnetics design can be realized at the same time.

Comparison of the volt-seconds are shown graphically in FIG. 33b in which dotted lines illustrate the flux density needs of forward, AHB and bridge-type DC-DC converters and heavy line the flux density requirement for present invention. Note how with the increased duty ratio, the flux density requirements rapidly decrease, resulting in further magnetics size reduction, while in forward and AHB converter are constant and independent of operating duty ratio.

The highest magnetics design efficiency is obtained when the transformer is designed with one turn for secondary winding, such as, for example for 5V output. In that case, flux per turn is for forward and AHB converter equal to 5V per turn, or as is often said, the magnetics core is chosen so that it can support 5 Volts/turn flux. Note now a very severe limitation if one wants to use the same core for 15V output. In order to keep the same core losses, the designer than choose transformer with three turns for secondary resulting in the same flux of 5 Volts/turn. However, increase of secondary turns (and corresponding primary number of turns as well) from one to three in same window spacing would result in a very high increase of copper losses. The comparably much lower low flux in the present invention gives a very efficient alternative. Now 15V output voltage designs could also be made with a single turn and result in much reduced conduction losses and improved efficiency. This is very important for practical server power supplies, which require 12V output as well as for battery charger applications having 15V and higher output voltages. The present invention then offers both smaller size and more efficient magnetics designs.

The same reduced size and higher efficiency are also directly applicable to the output inductor, as it has the same voltage waveforms excitation of FIG. 33a as the isolation transformer. The identical voltage excitations also make possible integration of the transformer and output inductor on the common core as describe in later section.

The next section demonstrates how the reductions of the magnetics size goes hand in hand with the simultaneous reduction of the voltage stresses on the switches. Thus, by operating in the optimum operating region, both smaller size magnetics, higher efficiency magnetics, and lower voltage stresses of output switch with reduced conduction losses can be obtained simultaneously.

### Comparison of the Voltage Stresses of Output Switches

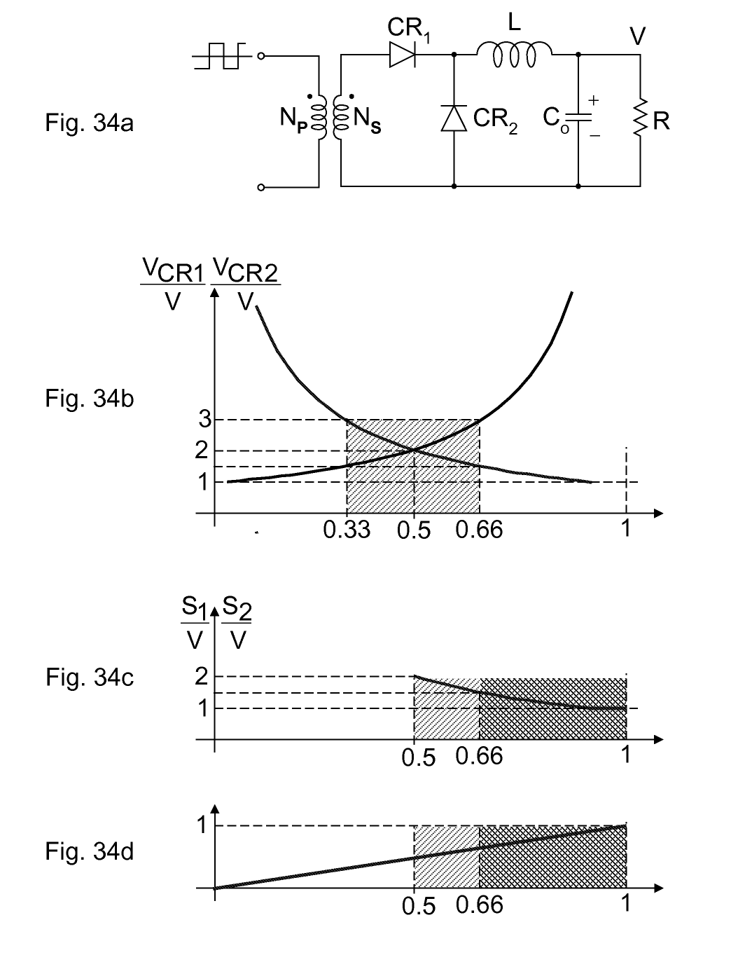

One of the key limitations of the prior-art converters is in the excessive voltage stresses of the output current rectifier switches. The secondary side rectification of the prior-art forward and AHB converters shown in FIG. 34a results in excessive voltage stresses of the output switches as illustrate in FIG. 34b. For example, for 12V output, the switches with 60V or even 80V rating must be utilized. The present invention operating at duty ratio D=0.66 as illustrated in FIG. 34c and FIG. 34d would result in only 50% higher voltage stress than the output DC voltage or 18V. Considering the stressless switching of the single diode switch, which turns ON and turns OFF under ideal conditions (zero voltage and zero current), one can safely use 30V rated switches. Therefore, the prior-art converters would result in at least four times higher conduction losses as 60V rated switches have four times higher ON-resistance than 30V rated switches.

### Simultaneous Reduction of Magnetic Size and Voltage Stresses

The present invention was shown to have two unique features not present in prior-art converters:

1. Substantial magnetic size reduction;

2. Very low voltage stresses on all switches.

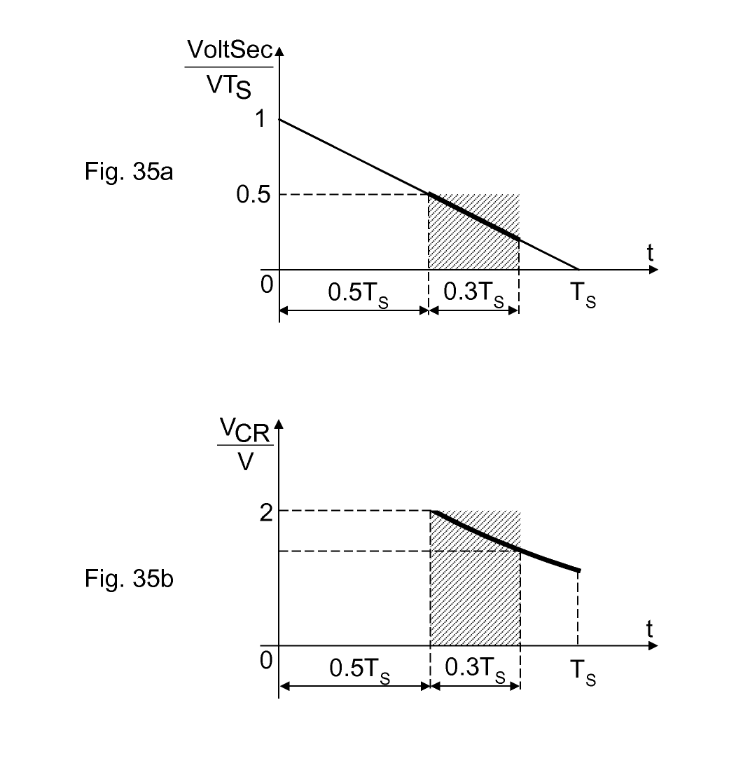

Now we will demonstrate that both unique advantages are obtained simultaneously and that lower magnetics size is also followed at the same time by lower stresses on the output diode switch as illustrated by the shaded area in FIG. 35a and FIG. 35b. Note that the operation at higher duty ratios leads at the same time to lower flux in the magnetics and lower voltage stress of the output switch. For example, the operation at D=0.66 results in three times reduction of the flux compared to prior-art converters. It also at the same time results in voltage stress on output switch, which is only 50% higher than output DC voltage.

Therefore, the two problems limiting the efficiency of converters are simultaneously eliminated. Operation at this operating point allows for transformer to be designed with only one turn secondary and still use the core size normally reserved for 5V outputs. Furthermore, the output switch can be implemented with a 30V rated switches instead of 80V rated switches used in prior-art converters. This together with the elimination of switching losses of all three switches results in efficiency substantially increased compared to the prior-art converters. Furthermore, the efficiency improvements come with the simultaneously reduced cost as the lower voltage rated switches are less expensive. Similarly smaller size magnetics and single turn use result in the reduced magnetics cost as well.

From the graphs in FIG. 35a and FIG. 35b one might conclude that the optimum operation would be at duty ratio near 1 as the magnetics size would be the smallest and voltage stress would be the smallest. However, the rms currents would start to increase substantially in that area thus diminishing advantages. Therefore, the optimum operating region is limited to the duty ratio of around D=0.8 as illustrated by the shaded area in FIG. 35a and FIG. 35b.

### Integrated Magnetics

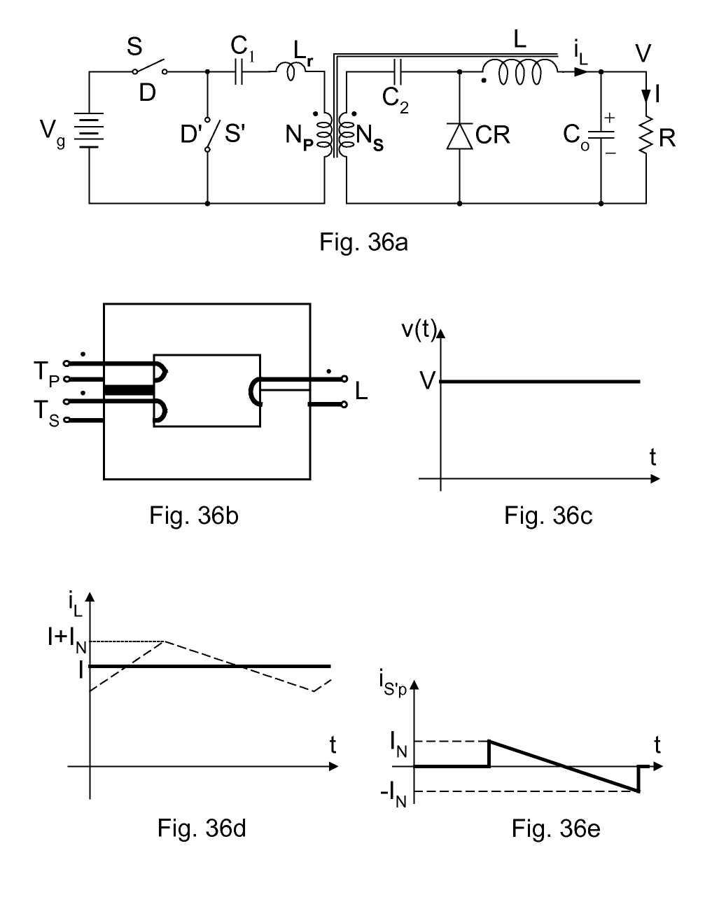

The identical voltage waveforms of the isolation transformer and the output inductor permit their integration as shown in Integrated Magnetics extension of FIG. 36a, in which the isolation transformer and output inductor are coupled together into a single Integrated Magnetic of FIG. 36b. By placing the transformer on the magnetic leg with an air-gap, and output inductor on the un-gapped leg, the ripple current is steered from the output inductor (FIG. 36d) into the transformer primary. The resulting zero ripple output inductor current also leads to very small output ripple voltage of typically 20 mV for 12V output. Thus, output voltage in FIG. 36c is shown to be essentially DC voltage with negligible ripple.

Another side benefit of ripple steering is that the switch S′ will now have some finite negative current at the end of switching interval to help with zero voltage switching of switch S even when the switch S′ would otherwise have zero current at that instant since the resonant current is reduced to zero at that instant such as illustrated in FIG. 36e.

### Experimental Verification

The experimental prototype of a 600 W, 400V to 12V converter is built to verify several unique advantages of the converter such as:

1. Magnetics design with only one turn for 12V output;

2. Use of the 30V rated switches for 12V output;

3. Streesless switching operation of the secondary side switch;

4. Use of 500V switches for 400V input voltage;

5. Elimination of the switching losses of the primary side switches.

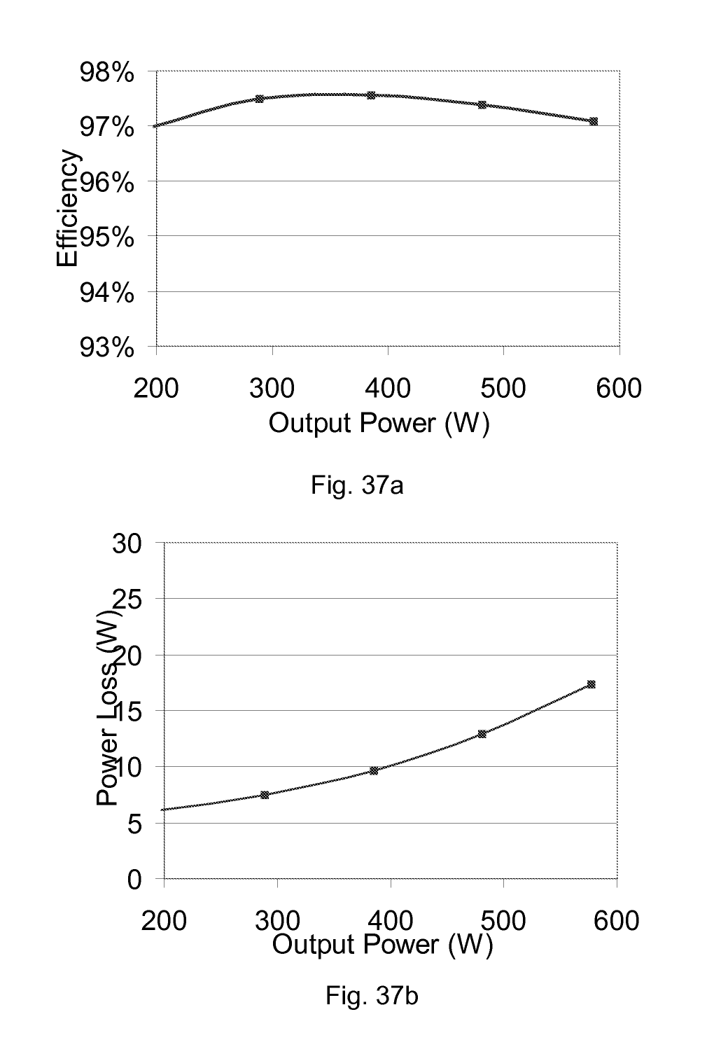

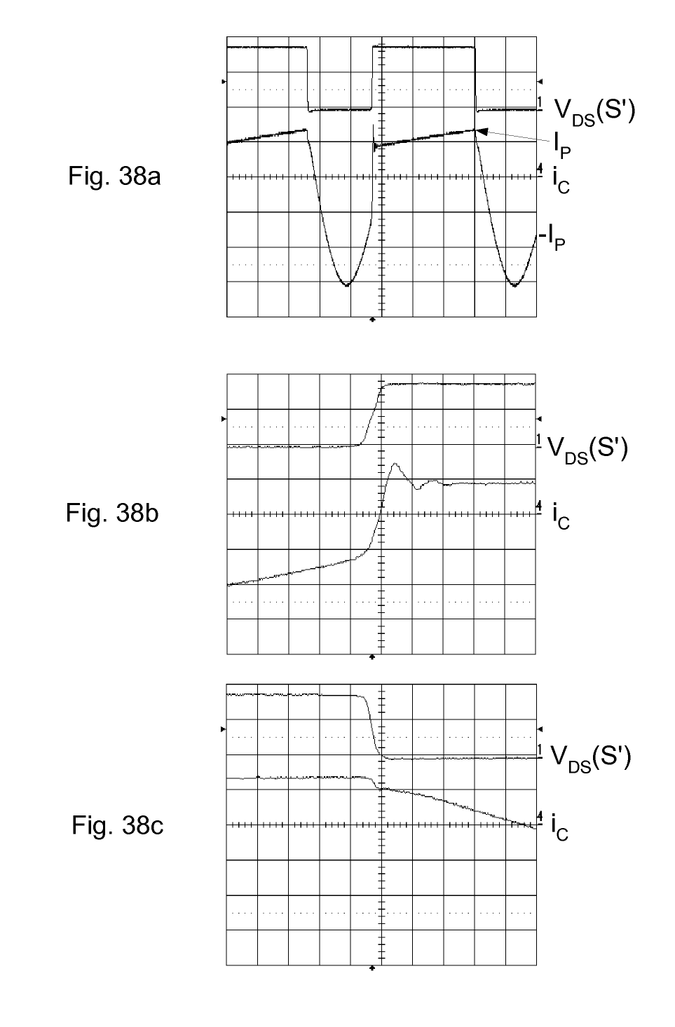

All these features are experimentally verified and result in very high efficiency as shown in FIG. 37a and power loss measurements in FIG. 37b for a wide power output range from 200 W to near 600 W. The switching performance was measured and shown in FIGS. 38a-c, which confirms the switching loss elimination of primary side switches.

### CONCLUSION

A new Single-stage DC-AC inverter eliminates the unfolding stage consisting of four transistors switching at the line frequency. It practical implementation consists of 4 MOSFET transistors, compared to 12 MOSFET transistors needed in the conventional DC-AC inverters based on full-bridge DC-DC converter topology. The isolation transformer also has the reduced AC flux and results in smaller size magnetics.

### REFERENCES

1. Slobodan Cuk, R. D. Middlebrook, “Advances in Switched-Mode Power Conversion”, Vol. 1, II, and III, TESLAco 1981 and 1983.
2. Alan Cocconi, Slobodan Cuk, and R. D. Middlebrook, “High-Frequency Isolated 4 kW Photovoltaic Inverter for Utility Interface”, Seventh International PCI '83 conference, Sep. 13-15, 1983, Geneva, Switzerland.

What is claimed is:

1. A high-frequency isolated switching DC-to-AC inverter for providing power from a DC source connected between an input terminal and a common input terminal to an output AC load connected between an output terminal and a common output terminal, said inverter comprising:
an isolation transformer operating at high switching frequency with primary and secondary windings, each winding having one dot-marked end and another unmarked end, wherein said unmarked end of primary winding is connected to said common input terminal and said unmarked end of secondary winding is connected to said common output terminal, whereby any AC voltage applied to said primary winding of said isolation transformer induces AC voltage in said secondary winding of said isolation transformer so that both AC voltages are in phase at dot-marked ends of said primary and secondary windings of said isolation transformer;
a first input switch with one end connected to said input terminal;
an inductor with one end connected to said output terminal;
a resonant inductor with one end connected to said dot-marked end of said primary winding;
a first resonant capacitor with one end connected to another end of said first switch and another end connected to another end of said resonant inductor;
a second input switch with one end connected to said common input terminal and another end connected to said another end of said first input switch;
a second resonant capacitor with one end connected to another end of said inductor and another end connected to said dot-marked end of said secondary winding;
an output switch with one end connected to said common output terminal and another end connected to said another end of said inductor.
switching means for keeping said first input switch ON and said second input switch and said output switch OFF for a duration of time interval DT_{S}, and keeping said first input switch OFF and said second input switch and said output switch ON for a duration of a complementary duty ratio interval (1−D)T_{S}, to provide a positive voltage to said AC load, and keeping said second input switch ON and said first input switch and said output switch OFF for a duration of time interval DT_{S}, and keeping said second input switch OFF and said first input switch and said output switch ON for a duration of a complementary duty ratio interval (1−D)T_{S}, to provide a negative voltage to said AC load wherein D is an operating duty ratio and T_{S} is a switching period;
wherein said resonant inductor and said first and second resonant capacitors form the resonant circuit during the said OFF-time interval and define a constant resonant frequency and a corresponding constant resonant period;
wherein said OFF-time interval is adjusted to be equal to a half of said resonant period;
wherein said ON-time interval is adjustable to result in duty ratio modulation of the output voltage, and
wherein said operating duty ratio D is modulated in a sinusoidal way with the modulation frequency equal to the line frequency, so that a sinusoidal AC voltage at the line frequency is provided to said AC load.

2. A converter as defined in claim 1,
wherein said input DC source consists of solar cells;
wherein said AC load is a utility line;
wherein said sinusoidal AC voltage is interfaced to said utility line with additional control means to provide the active power only to the utility line, and
wherein additional maximum power tracking circuit is provided to extract the maximum power form said DC source.

3. A converter as defined in claim 1,
wherein said first and second input switches are MOSFET transistors;
wherein said output switch is a composite switch comprising two MOSFET transistors with their sources connected together and their gates connected together to perform as a current bi-directional and voltage bi-directional two-quadrant switch.

4. A converter as defined in claim 1,
wherein said resonant inductor is shorted;
wherein a leakage inductance of said isolation transformer takes the role of the eliminated said resonant inductor, and
whereby the resonant frequency and resonant period are adjusted by selecting a proper value of said first resonant capacitor as said leakage inductance of said isolation transformer is relatively fixed by said isolation transformer design.

5. A converter as defined in claim 1,
wherein said isolation transformer is disconnected and removed;
wherein said one end of said resonant inductor is connected to said another end of said second resonant capacitor;
wherein said common input terminal is connected to said common output terminal, and
whereby a non-isolated DC-AC inverter is provided.

6. A high-frequency isolated switching DC-to-AC inverter for providing power from a DC source connected between an input terminal and a common input terminal to an output AC load connected between an output terminal and a common output terminal, said inverter comprising:
an isolation transformer operating at high switching frequency with primary and secondary windings, each winding having one dot-marked end and another unmarked end, wherein said unmarked end of primary winding is connected to said common input terminal and said unmarked end of secondary winding is connected to said common output terminal, whereby any AC voltage applied to said primary winding of said isolation transformer induces AC voltage in said secondary winding of said isolation transformer so that both AC voltages are in phase at dot-marked ends of said primary and secondary windings of said isolation transformer;
an first input switch with one end connected to said input terminal;
an inductor with one end connected to said output terminal;
a resonant inductor with one end connected to said dot-marked end of primary winding
a first capacitor with one end connected to another end of said first input switch and another end connected to the other end of said resonant inductor;
a second input switch with one end connected to said common input terminal and another end connected to said one end of said first capacitor;
a second capacitor with one end connected to another end of said inductor and another end connected to said dot-marked end of said secondary winding;
an output switch with one end connected to said common output terminal and another end connected to said another end of said inductor;
wherein said first and said second switch are MOSFET transistors;
wherein said output switch is a composite switch consisting of two MO SFET transistors with their sources connected together and their gates connected together so as to perform the two quadrant function;
switching means for keeping said first switch ON and said second and said third switch OFF for a duration of ON-time interval DT_{S}, and for keeping said first switch OFF and said second and said third switch ON for a duration of OFF-time interval D′T_{S} so that positive polarity output voltage is obtained where D is duty ratio and D′ is complementary duty ratio within one complete and controlled switch operating cycle T_{S};
switching means for keeping said first switch and said third switch ON and said second switch OFF for a duration of OFF-time interval D′T_{S}, and for keeping said second switch ON and said first switch and said third switch OFF for a duration of ON-time interval DT_{S} so that negative polarity output voltage is obtained;
wherein said resonant inductor and the first and second capacitors form the resonant circuit during the said OFF-time interval and define a constant resonant frequency and a corresponding constant resonant period;
wherein said OFF-time interval is adjusted to be equal to a half of the said resonant period;
wherein the ON-time interval is adjustable to result in duty ratio modulation of the output voltage;
wherein the duty ratio D is modulated in a sinusoidal way with the modulation frequency equal to the line frequency, so that the full-wave sinusoidal output AC voltage at the line frequency is obtained;
control means for providing the power flow from a DC input to an AC output or from an AC output to DC input;
wherein said high-frequency isolated bi-directional DC-AC inverter is capable to exchange the power between a DC transmission line and an AC transmission line in either direction;
wherein the surplus of power on DC transmission line can be sent to AC transmission line;
wherein the surplus of power on AC transmission line can be sent to a DC transmission line;
wherein such bi-directional power capability provides an efficient load balancing of supporting the AC transmission line during the day from the surplus power generated by solar cells, and
wherein such bi-directional power capability provides an efficient load balancing of supporting the DC transmission line during the night from the surplus power generated on the AC transmission line.

7. A converter as defined in claim 6,
wherein said input DC source is a battery, and
wherein said AC load can use the reactive power.

8. A converter as defined in claim 6,
wherein the resonant inductor is replaced by a short;
wherein the leakage inductance of the isolation transformer takes the role of the eliminated external resonant inductor, and
whereby the resonant frequency and resonant interval are adjusted by selecting a proper value of said first capacitor as the leakage inductance of the isolation transformer is relatively fixed by transformer design.

9. A high-frequency isolated DC-AC inverter as in claim 6,
wherein the isolation transformer is removed (shorted) to result in a non-isolated DC-AC inverter.

10. A non-isolated DC-AC inverter as in claim 8,
wherein the input DC voltage sources consists of solar cells;
wherein the output AC voltage is interfaced to the utility line with additional control means so that the solar source provides the active power only to the utility line, and
wherein additional maximum power tracking circuit is provided to extract the maximum power form the solar cells source.
